(19) United States
(12) Patent Application Publication
(10) Pub. No.: US 2010/0209131 A1
(43) Pub. Date: Aug. 19, 2010

(54) FIXING DEVICE, IMAGE FORMING APPARATUS, RECORDING MEDIUM RECORDING CONTROL PROGRAM FOR REALIZING FIXING DEVICE AND CONTROL METHOD FOR FIXING DEVICE

(76) Inventors: Toshiaki KAGAWA, Osaka (JP); Hiroyuki Kageyama, Osaka (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/703,863

(22) Filed: Feb. 11, 2010

(30) Foreign Application Priority Data
Feb. 18, 2009 (JP) 2009-035921

(51) Int. Cl. G03G 15/20

(52) U.S. Cl. 399/70

(57) ABSTRACT

A fixing device is provided. A fixing device includes a heating section that has a heat source comprised of a ceramic heat generating element that generates heat by electric power supply and has a positive temperature coefficient property. Then, in the heating section, an applied voltage value by a voltage variable power source to the ceramic heat generating element is variably controlled by a control unit such that an input power value in the ceramic heat generating element is approximately constant.

### CROSS-REFERENCE TO RELATED APPLICATION

This application claims priority to Japanese Patent Application No. 2009-035921, which was filed on Feb. 18, 2009, the contents of which are incorporated herein by reference in its entirety.

### BACKGROUND OF THE INVENTION

1. Field of the Invention

The present invention relates to a fixing device, an image forming apparatus, a recording medium recording a control program for realizing the fixing device and a control method for the fixing device.

2. Description of the Related Art

An electrophotographic image forming apparatus, which forms an image on the basis of electrophotography, can easily form the image having a good image quality, and hence, it is utilized widely for a copier, a printer, a facsimile equipment, a multifunctional peripheral, etc.

An electrophotographic image forming apparatus (hereinbelow, simply referred to as “image forming apparatus”) includes, for example, a photoreceptor, a charging section, an exposure section, a developing section, a transfer section and a fixing section. The image forming apparatus is an apparatus which performs a charging process, an exposure process, a development process, a transfer process and a fixation process by employing the photoreceptor and these components, and which forms the image on a fixing material.

As the fixing unit which performs the fixation process, for example, a fixing device of heat-roller fixing type is employed. The fixing device of the heat-roller fixing type includes a fixing roller and a pressure roller. The fixing roller and the pressure roller are a pair of rollers which are brought into pressure-contact with each other. Inside at least one of the fixing roller and the pressure roller, a heat source such as halogen heater is disposed as a heating section.

In the fixation process, after the heat source has heated the roller pair to a predetermined temperature necessary for fixation (hereinbelow, referred to as “fixing temperature”), the fixing material on which an unfixed toner image is formed is fed to a fixing nip region which is a pressure-contact region between the fixing roller and the pressure roller. The unfixed toner image which passes through the fixing nip region, is fixed onto the fixing material such as paper under heat conducted from at least one of the fixing roller and the pressure roller, and the pressures of the fixing roller and the pressure roller. In the fixing nip region, a part through which the fixing material has passed (hereinbelow, referred to as “paper sheet passing part”) has its temperature lowered, but it is heated to the fixing temperature by the heat source.

A fixing device provided in a color image forming apparatus capable of full-color printing employs an fixing roller (hereinbelow referred to as “elastic roller”) providing an elastic layer made for example of silicone rubber on a surface layer thereof. By using the elastic roller, the elastic layer provided on the surface of the elastic roller in the fixing nip region can become elastically deformed so as to conform to irregularities of the unfixed toner image, wherefore the elastic roller makes contact with the toner image so as to cover the surface of the unfixed toner image. This makes it possible to improve fixation on the unfixed color toner image that is larger in toner adherent amount than a monochromatic toner image. Moreover, by virtue of a deflection-releasing effect exerted by the elastic layer provided on the surface of the elastic roller in the fixing nip region, it is possible to provide enhanced releasability for a color toner that is more susceptible to occurrence of offset than a monochromatic toner image. Concretely, the elastic layer of the fixing roller as has been compressed by the fixing nip region and has undergone a distortion has the distortion released at the exit of the fixing nip region. At the exit of the fixing nip region, therefore, a deviation occurs between the elastic layer and the toner image. As a result, the adhesive force of the elastic layer to the toner image is decreased, and the toner releasability of the elastic layer is enhanced. Further, since the fixing nip configuration which is a configuration of the fixing roller and a pressure roller in the fixing nip region, is convexly curved in a radially-outward direction (a reverse nip configuration), it is possible to attain higher paper-stripping capability of the fixing roller and the fixing material. Thus, a self-stripping action capable of stripping of the fixing material and the fixing roller can be realized without using, for example, a stripping pawl as a stripping portion for stripping the fixing roller and the fixing material of each other, wherefore image imperfection caused by the provision of the stripping portion can be eliminated.

However, in such a fixing device of a heat roller fixing type, there is a problem that a warm-up time is to be very long since heat conductivity of an elastic layer of the fixing roller is very poor, in addition to heat capacity of the fixing roller being great, and the fixing roller is indirectly heated by a heat source disposed inside thereof.

Therefore, to solve the above problem, Japanese Unexamined Patent Publication JP-A 2002-333788 discloses a fixing device of a belt fixing type in which, instead of a fixing roller, a fixing belt whose heat capacity is small and having a thin elastic layer is used, and performs heating by directly abutting a heating member that includes a planar heat generating element against the fixing belt.

However, in the fixing device disclosed in JP-A 2002-333788, since the planar heat generating element included in the heating member that is directly abutted against the fixing belt has a quite high power density adding to the heat capacity being very small, when in a state where a control section for controlling electric power supply to the planar heat generating element is broken down and the electric power supply to the planar heat generating element is not to be halted, there is a problem that an abnormal temperature rise in the planar heat generating element is caused instantly and the safety is not able to be secured sufficiently.

Against this, Japanese Unexamined Patent Publication JP-A 5-216357 (1993) discloses a fixing device of a belt fixing type in which a planar heat generating element provided in a heating member abutting against a fixing belt is a heat generating element having a positive temperature coefficient property.

In the fixing device disclosed in JP-A 5-216357, since the planar heat generating element that generates heat by electric power supply is a heat generating element having a positive temperature coefficient property, by self-temperature controlling function of the heat generating element, when the temperature of the heat generating element exceeds a Curie point (for example, 225° C.), an electric resistance value rises suddenly and heating is automatically suppressed. Therefore, even in a state where the control section for controlling electric power supply to the planar heat generating element is broken down and the electric power supply to the planar heat generating element is not to be halted, the temperature rise in the planar heat generating element is halted at a predetermined temperature (Curie point), and the safety is able to be secured sufficiently.

However, the heat generating element having the positive temperature coefficient property has slight temperature dependency and an electric resistance value varies even when the temperature of the heat generating element is in a temperature region of the Curie point or lower. Therefore, voltage is applied to the planar heat generating element that has a positive temperature coefficient property by using a power source of constant voltage (for example, 100 V in Japan), depending on the variation of the electric resistance value with the slight temperature dependency, an input power value in the planar heat generating element also varies and a constant power value which is necessary all the time is not able to be obtained.

For example, in the fixing device, during a warm-up time when the temperature of the heat generating element rises from a normal temperature (20° C.) to a fixation temperature (200° C.) which is the Curie point or lower, the electric resistance value of the planar heat generating element varies within a range in which maximum power value is 4.2 times as a minimum power value, depending on the variation of the temperature of the heat generating element. In this way, when the electric resistance value in the planar heat generating element varies, an input power value in the planar heat generating element during the warm-up time varies within the range in which the maximum power value is 4.2 times as the minimum power value, and a warm-up time is to be long.

In addition, in the fixing device, when setting value of fixation temperature is changed depending on quality of fixing material, and a temperature of an environment in which the fixing device is installed, the input power value in the planar heat generating element also varies and securing of stable fixation performance is not possible.

### SUMMARY OF THE INVENTION

An object of the invention, accordingly, is to provide a fixing device that heats a toner image borne on a fixing material to a fixation temperature to fix by a heating section including a heat generating element that has a positive temperature coefficient property, in which during a warm-up time when temperature variation in a heat generating element is generated, a warm-up time is prevented to be long and stable fixation performance is able to be secured, and to provide an image forming apparatus provided with the fixing device. Furthermore, an object of the invention is to provide a recording medium recording the control program for realizing the fixing device, as well as a control method for the fixing device.

The invention provides a fixing device comprising a heating section for heating a toner image borne on a fixing material, the heating section heating the toner image at a predetermined fixation temperature to fix the image on the fixing material, the heating section comprising:

a heating member including a ceramic heat generating element that generates heat by electric power supply and has a positive temperature coefficient property, and a heating base material through which heat generated from the ceramic heat generating element is conducted;

a voltage variable power source which applies a voltage to the ceramic heat generating element, the voltage variable power source being capable of variably controlling an applied voltage value; and

a control unit that variably controls the applied voltage value by the voltage variable power source to the ceramic heat generating element such that an input power value in the ceramic heat generating element is to be approximately constant.

According to the invention, the fixing device is a device that heats a toner image borne on a fixing material at a predetermined fixation temperature to fix by a heating section that has a heat source comprised of a ceramic heat generating element that generates heat by electric power supply and has a positive temperature coefficient (PTC) property. Then, in the heating section, the applied voltage value by the voltage variable power source to the ceramic heat generating element is variably controlled by the control unit such that an input power value in the ceramic heat generating element is approximately constant.

The ceramic heat generating element having the PCT property is a heat generating element which shows rapid rise of an electric resistance value in a case of exceeding a predetermined temperature (Curie point), and even when the rise of temperature starts, an excessive rise of the temperature is suppressed by suppressing current due to rise of the electric resistance value, however, even in a temperature region which is the Curie point or less, variation of the electric resistance value is generated.

In the fixing device of the invention, even during a warm-up time when the temperature of the ceramic heat generating element rises from the normal temperature (for example, 20° C.) to the predetermined temperature (for example, 200° C.), the control unit variably controls the applied voltage value by the voltage variable power source to the ceramic heat generating element, and thereby the input power value in the ceramic heat generating element is approximately constant depending on the variation of the electric resistance value. In this way, since the input power value in the ceramic heat generating element is approximately constant during a warm-up time when the electric resistance value varies depending on the temperature change of the ceramic heat generating element, a warm-up time is prevented to be long. Additionally, in the fixing device of the invention, even when the setting value of the predetermined fixation temperature is changed depending on the quality of the fixing material, the temperature of the environment in which the fixing device is installed, since the input power value in the ceramic heat generating element is approximately constant, stable fixation performance is able to be secured. Further in the fixing device of the invention, the input power value in the ceramic heat generating element is approximately constant depending on the variation of the electric resistance value accompanied by the temperature variation of the ceramic heat generating element, it is possible to exercise the heat generating capability of the ceramic heat generating element at a maximum without exceeding a rated power value.

Further, in the invention, it is preferable that the control unit includes:

a detection section that detects a current value or electric resistance value of the ceramic heat generating element;

a calculation section that calculates the applied voltage value with which an input power value for the ceramic heat generating element is approximately constant based on the current value or electric resistance value detected by the detection section; and

a control section that causes the voltage variable power source to apply a voltage corresponding to the applied voltage value calculated by the calculation section.

According to the invention, the control unit includes the detection section, the calculation section and the control section. In the control unit, based on the current value or electric resistance value of the ceramic heat generating element detected by the detection section, the calculation section calculates the applied voltage value with which an input power value for the ceramic heat generating element is approximately constant, and the control section causes the variable voltage power source to apply a voltage corresponding to the applied voltage value calculated by the calculation section. In this way, the control unit that variably controls the applied voltage value by the voltage variable power source such that the input power value in the ceramic heat generating element is approximately constant depending on the variation of the electric resistance value, is realized.

Furthermore, in the invention, it is preferable that the fixing device includes a fixing belt that is formed as an endless-shaped belt member and is disposed so as to rotate in contact of its outer circumferential surface with a toner image bearing surface of the fixing material on which a toner image is borne, and

the heating section is disposed such that the heating base material comes in contact with an inner circumferential surface of the fixing belt, and a toner image is heated through the fixing belt.

According to the invention, the fixing device is further provided with the fixing belt, and the heating section is configured so as to heat a toner image on a fixing material through the fixing belt. Then, the heating section is disposed such that the heating base material comes in contact with the inner circumferential surface of the fixing belt. The fixing belt is a member which is able to be designed such that the heat capacity is small. Since the heating section directly contacts and heats the fixing belt described above, compared with the case where the roller-shaped fixing roller of the large roller shape whose heat capacity is great is heated indirectly by the heat source disposed inside thereof, a warm-up time is able to be shortened.

Further, in the invention, it is preferable that the fixing device includes a fixing member that is disposed in contact with the inner circumferential surface of the fixing belt, and a pressure member coming in pressure-contact with the fixing member with the fixing belt interposed therebetween, and

the heating section is configured so as to provide heat through the fixing belt, a toner image borne on a fixing material passing between the fixing belt and the pressure member.

According to the invention, the fixing device includes a fixing member disposed in contact with the inner circumferential surface of the fixing belt, and a pressure member coming in pressure-contact with the fixing member with the fixing belt interposed therebetween. Then, the heating section is configured so as to provide heat through the fixing belt, a toner image borne on a fixing material passing between a fixing belt and a pressure member. In the fixing device of such configuration, a toner image on the fixing material is fixed when passing between the fixing member and the pressure member which come in pressure-contact with each other with the fixing belt interposed therebetween. Therefore, the toner image on the fixing material is heated by the heating section through the fixing belt and pressurized by a pressure-contact force generated between the fixing member and the pressure member, thus further stable fixation performance is able to be secured.

Further, in the invention, it is preferable that the fixing device includes a pressure member coming in pressure-contact with the heating base material disposed so as to come in contact with the inner circumferential surface of the fixing belt, with the fixing belt interposed therebetween, and

the heating section is configured to heat a toner image borne on the fixing material passing between the fixing belt and the pressure member through the fixing belt.

According to the invention, the fixing device includes a pressure member coming in pressure-contact with a heating base material of a heating section disposed so as to come in contact with the inner circumferential surface of the fixing belt. The heating section is, then, configured such that a toner image borne on the fixing material passing between the fixing belt and the pressure member is heated through the fixing belt. In the fixing device of such configuration, a toner image on the fixing material is fixed when passing between the heating base material and the pressure member of the heating section in pressure-contact with each other with the fixing belt interposed therebetween. Therefore, a toner image on the fixing material is heated by the heating section through the fixing belt, and pressurized by the pressure-contact force generated between the heating base material and the pressure member of the heating section, more stable fixation performance is able to be secured. Moreover, as the heating base material and the pressure member of the heating section are configured to be in pressure-contact with each other with the fixing belt interposed therebetween, without providing other member such as a fixing member in pressure-contact with the pressure member, the pressure-contact force is able to be imparted to a toner image on the fixing material, and the simplification of the configuration of the fixing device is possible.

Further, in the invention, it is preferable that the fixing device includes a fixing member that comes in contact with a toner image bearing surface of a fixing material on which a toner image is borne, a pressure member coming in pressure-contact with the fixing member, and a heating belt that is an endless-shaped belt member and is disposed so as to rotate in contact of its inner circumferential surface with the heating base material and in contact of its outer circumferential surface with the fixing member, and

the heating section is configured to heat a toner image borne on a fixing material passing between the fixing member and the pressure member through the heating belt and the fixing member.

According to the invention, the fixing device includes a fixing member that comes in contact with a toner image bearing surface of a fixing material, a pressure member coming in pressure-contact with the fixing member, and a heating belt which is disposed so as to rotate in contact of its inner circumferential surface with the heating base material of the heating section and in contact of its outer circumferential surface with the fixing member. Then the heating section is configured so as to heat a toner image on the fixing material passing between the fixing member and the pressure member through the heating belt and the fixing member. In the fixing device of such configuration, a toner image on the fixing material is fixed when passing between the fixing member and the pressure member in pressure-contact with each other. At this time, a toner image on the fixing material comes in contact with the heating base material of the heating section and receives heating from the fixing member through the heating belt that comes in contact with the fixing member, as well as pressurized by the pressure-contact force generated between the fixing member and the pressure member, thus enabling to secure more stable fixation performance.

Further, in the invention, it is preferable that the control unit is configured such that the applied voltage value by the voltage variable power source to the ceramic heat generating element is variably controlled in a direction opposite to a direction of change of a current value in the ceramic heat generating element.

According to the invention, the control unit is configured such that the applied voltage value by the voltage variable power source to the ceramic heat generating element is variably controlled in the direction opposite to the direction of a change of the current value in the ceramic heat generating element. Whereby, the input power value in the ceramic heat generating element is caused to be approximately constant, and a warm-up time is prevented to be long.

Further, in the invention, it is preferable that the control unit is configured such that the applied voltage value by the voltage variable power source to the ceramic heat generating element is variably controlled in a direction same as the direction of a change of a resistance value in the ceramic heat generating element.

According to the invention, the control unit is configured such that the applied voltage value by the voltage variable power source to the ceramic heat generating element is variably controlled in the direction same as the direction of a change of a resistance value in the ceramic heat generating element. Thus, the input power value in the ceramic heat generating element is caused to be approximately constant, and a warm-up time is prevented to belong.

Further, in the invention, it is preferable that the heating section has a heating operation mode and a warm-up mode, the heating operation mode being a mode in which a heating operation is performed for heating a toner image borne on the fixing material at a predetermined fixation temperature, and the warm-up mode being a mode as a state before the heating operation which mode is performed until a temperature of the ceramic heat generating element rises from the normal temperature to the predetermined fixation temperature, and

the control unit is configured to variably control the applied voltage value by the voltage variable power source to the ceramic heat generating element such that the input power value in the ceramic heat generating element is approximately constant at a higher value in the warm-up mode than in the heating operation mode.

According to the invention, the heating section has the heating operation mode and the warm-up mode. The heating operation mode is a mode in which a heating operation is performed for heating a toner image on the fixing material at a predetermined fixation temperature, and a warm-up mode is a mode as a state before the heating operation which mode is performed until the temperature of the ceramic heat generating element rises from the normal temperature to the predetermined fixation temperature. Then, the control unit variably controls the applied voltage value by the voltage variable power source to the ceramic heat generating element such that the input power value in the ceramic heat generating element is approximately constant at a higher value in the warm-up mode than in the heating operation mode. Since the control unit variably controls the applied voltage to the ceramic heat generating element such that an input power value in the ceramic heat generating element is approximately constant at a higher value in the warm-up mode that requires a temperature of the ceramic heat generating element to be risen from the normal temperature to the predetermined fixation temperature, thus allowing a warm-up time to be shortened.

Further, in the invention, it is preferable that the control unit is configured such that, when the detection section detected a minimum electric resistance value Rmin (Ω) in a use temperature range of the ceramic heat generating element, the calculation section calculates the applied voltage value Vmin (V) within a range in which the following formula (i) is satisfied:

Vmin≧Vc (i)

where Vc is the rated voltage value.

According to the invention, in the control unit, when the detection section detects the minimum electric resistance value Rmin (Ω) in the use temperature range of the ceramic heat generating element, the calculation section calculates the applied voltage value Vmin (V) within a range in which Vmin≧Vc (herein, Vc is the rated voltage value) is satisfied. Thereby, flowing of overcurrent through the ceramic heat generating element is able to be prevented and the safety is able to be secured.

In the invention, it is preferable that the ceramic heat generating element is a member that is set such that, when a maximum input power value is Pmax (W), the minimum electric resistance value Rmin (Ω) within the use temperature range satisfies the following formula (ii):

Rmin≧Vc²/Pmax (ii)

where Vc is the rated voltage value.

According to the invention, the ceramic heat generating element is a member which is set such that, when a maximum input power value is Pmax (W), the minimum electric resistance value Rmin (Ω) within the use temperature range satisfies Rmin≧Vc²/Pmax. Such a ceramic heat generating element is a heat generating element in which flowing of overcurrent is prevented, and the safety is able to be secured.

Further, in the invention, it is preferable that the heating section includes a second heat generating element that is different from the ceramic heat generating element, and

the second heat generating element is configured to generate heat by applying a voltage from a second power source that is different from the voltage variable power source.

According to the invention, the heating section includes a second heat generating element that is different from the ceramic heat generating element. The second heat generating element generates heat by applying a voltage from the second power source that is different from the voltage variable power source. Since the ceramic heat generating element and the second heat generating element included in the heating section generate heat in a distinguished state by applying a voltage from a different power source, the heating section is able to widen a control width of heating conditions for a toner image on a fixing material depending on quality of the fixing material, temperature of an environment in which the fixing device is installed, and mode.

Further, in the invention, it is preferable that the second heat generating element is a halogen heater.

According to the invention, the second heat generating element included in the heating section is realized by a halogen heater.

Further, in the invention, it is preferable that the control unit is configured to variably control the applied voltage value by the voltage variable power source to the ceramic heat generating element, depending on whether or not the second heat generating element generates heat by applying a voltage from the second power source, such that an input power value in the ceramic heat generating element is approximately constant at a higher value when the second heat generating element is not generating heat than when the second heat generating element is generating heat.

According to the invention, the control unit variably controls the applied voltage value by the voltage variable power source to the ceramic heat generating element depending on whether or not the second heat generating element generates heat by applying a voltage. That is, the control unit makes it possible an input power value in the ceramic heat generating element is approximately constant at a higher value when the second heat generating element is not generating heat than when the second heat generating element is generating heat. Therefore, wasteful consumption of power in the heating section is prevented, and stable fixation performance is able to be secured depending on the quality of the fixing material, the temperature of an environment in which a fixing device is installed, and the mode.

Further, in the invention, it is preferable that the second heat generating element is a heat source for heating the pressure member.

According to the invention, the second heat generating element is a heat source for heating the pressure member that imparts a pressurizing force to a toner image on a fixing material. Thereby, when a toner image is to be fixed on the fixing material, the pressurizing force is imparted to the toner image by the pressure member and the heating section is able to heat the fixing material from both sides of the thickness direction, and the fixation performance is able to be improved.

The invention provides an image forming apparatus comprising: a toner image forming section for forming a toner image on a fixing material; and a fixing section for heating the toner image, which is the fixing device mentioned above, the fixing section heating the toner image formed on the fixing material by the toner image forming section to a predetermined fixation temperature to fix.

According to the invention, an image forming apparatus includes a toner image forming section for forming a toner image on a fixing material, and a fixing section for heating the toner image formed on the fixing material by the toner image forming section to a predetermined fixation temperature to fix. The image forming apparatus is then realized by being provided with the fixing device as a fixing section to fix a toner image.

Further, the invention may provide a control program for realizing the fixing device mentioned above, the control program causing a computer to function as the control unit.

According to the invention, control program is a program for causing a computer to function as the control unit. Such a control program is able to realize the fixing device with a computer.

The invention may provide a computer-readable recording medium recording the control program mentioned above.

According to the invention, a recording medium is realized by a computer-readable medium recording the control program. By causing a general-purpose computer such as a personal computer to read the control program recorded in the recording medium, even during a warm-up time when the temperature of the ceramic heat generating element having a PTC property rises from the normal temperature to the predetermined fixation temperature, the input power value in the ceramic heat generating element is caused to be approximately constant depending on the variation of the electric resistance value, and a warm-up time is prevented to be long. Moreover, by causing a computer to read the control program that is recorded in the recording medium, even in the case of changing, the setting value of the predetermined fixation temperature depending on the quality of the fixing material and temperature of an environment in which the fixing device is installed, the input value in the ceramic heat generating element is caused to be approximately constant, and the stable fixation performance is able to be secured.

Further, the invention provides a method of controlling a fixing device for heating a toner image borne on a fixing material to a predetermined fixation temperature to fix, with a heat source composed of a ceramic heat generating element which generates heat by electric power supply and has a positive temperature coefficient property, comprising:

a detecting step of detecting a current value or electric resistance value of the ceramic heat generating element;

a calculating step of calculating an applied voltage value with which an input power value to the ceramic heat generating element is approximately constant based on the current value or the electric resistance value detected at the detecting step; and

a voltage applying step of applying a voltage corresponding to an applied voltage value calculated in the calculating step to the ceramic heat generating element.

According to the invention, the present control method is a method of controlling a fixing device for heating a toner image borne on a fixing material at a predetermined fixation temperature to fix, with a heat source comprised of a ceramic heat generating element generating heat by electric power supply and having a PTC property. The method of controlling the fixing device includes a detecting step, a calculating step, and a voltage applying step. In the detecting step, a current value or electric resistance value of the ceramic heat generating element is detected. Next, in the calculating step, an applied voltage value with which an input power value to the ceramic heat generating element is approximately constant is calculated based on a detection result in the detecting step. Then, in the voltage applying step, voltage corresponding to an applied voltage value calculated in the calculating step is applied to the ceramic heat generating element. In the voltage applying step, even during a warm-up time when the temperature of the ceramic heat generating element having a PTC property rises from the normal temperature to the predetermined temperature, by applying a voltage corresponding to an applied voltage value with which an input power value is approximately constant, to the ceramic heat generating element, and a warm-up time is prevented to be long. Moreover, in the voltage applying step, even when a setting value of a predetermined fixation temperature is changed depending on the quality of the fixing material and a temperature of an environment in which a fixing device is installed, voltage corresponding to an applied voltage value with which the input power value is approximately constant is applied to the ceramic heat generating element, and the stable fixation performance is able to be secured.

### BRIEF DESCRIPTION OF DRAWINGS

Other and further objects, features, and advantages of the invention will be more explicit from the following detailed description taken with reference to the drawings wherein:

FIG. 1 is a view for showing a configuration of a fixing device according to a first embodiment of the invention;

FIG. 2 is a view showing a configuration of a heating section;

FIG. 3 is a plan view showing a configuration of a heating member;

FIG. 4 is a view showing a configuration of a fixing device according to a second embodiment of the invention;

FIG. 5 is a view showing a configuration of a fixing device according to a third embodiment of the invention;

FIG. 6 is a view showing a configuration of an image forming apparatus according to an embodiment of the invention;

FIG. 7 is a graph showing a relation between a temperature related to the ceramic heat generating element in a warm-up mode in a fixing device of Example 1, and an input power value, an applied voltage value, a current value and an electric resistance value;

FIG. 8 is a graph showing a relation between a temperature related to a ceramic heat generating element in a warm-up mode in a fixing device of Example 2, and an input power value, an applied voltage value, a current value and an electric resistance value;

FIG. 9 is a graph showing a relation between a temperature related to a ceramic heat generating element in a warm-up mode in a fixing device of Comparative Example 1, and an input power value, an applied voltage value, a current value and an electric resistance value;

FIG. 10 is a graph showing a relation between a temperature related to a ceramic heat generating element in a warm-up mode in a fixing device of Comparative Example 2, and an input power value, an applied voltage value, a current value and an electric resistance value; and

FIG. 11 is a view showing a configuration of a fixing device of a conventional art.

### DETAILED DESCRIPTION

Now referring to the drawings, preferred embodiments of the invention are described below.

(Fixing Device)

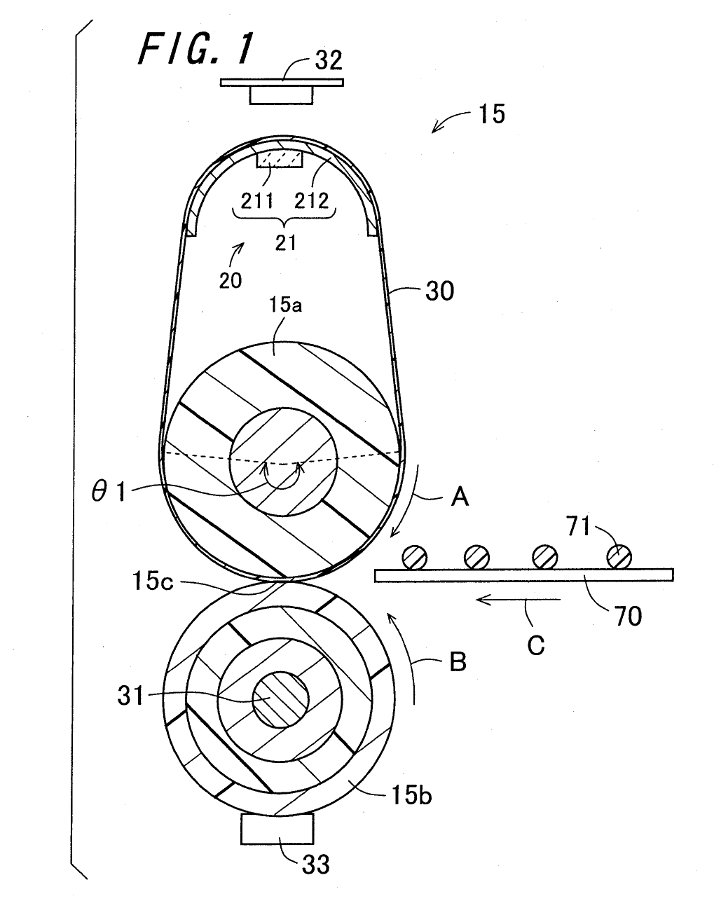

FIG. 1 is a view for showing the configuration of a fixing device 15 according to a first embodiment of the invention. The fixing device 15 includes a fixing roller 15a that is a fixing member, a pressure roller 15b that is a pressure member, a fixing belt 30 that is an endless-shaped belt member, and a heating section 20. In the fixing device 15, a fixing belt 30 is supported around the fixing roller 15a and a heating base material 212 included in a heating member 21 of the heating section 20, with tension, and the pressure roller 15b is disposed to face the fixing roller 15a with the fixing belt 30 interposed therebetween. Then, the fixing roller 15a and the heating base material 212 of the heating member 21 are disposed to be approximately parallel in an axial direction of the fixing roller 15a. That is, an axis of the fixing roller 15a and an axis of the heating base material 212 of the heating member 21 are approximately parallel to each other.

The fixing device 15 is a device in which the heating base material 212 of the heating member 21 coming in contact with an inner circumferential surface of the fixing belt 30, and when recording paper 70 as the fixing material passes at a predetermined fixation speed or duplication speed through a fixing nip region 15c that is formed between the fixing roller 15a and the pressure roller 15b in pressure-contact with each other with the fixing belt 30 interposed therebetween, heats and pressurizes an unfixed toner image 71 borne on the recording paper 70 to fix onto the recording paper 70. Note that, the unfixed toner image 71 is formed by, for example, a developer (toner) such as a non-magnetic one-component developer (non-magnetic toner), a non-magnetic two-component developer (non-magnetic toner and carrier), or a magnetic developer (magnetic toner). In addition, the fixation speed is a so-called processing speed, and the duplication speed is the number of copy sheets per one minute. The fixation speed and the duplication speed are not particularly limited thereto, and the fixation speed is 173 mm/sec in this embodiment. Moreover, when the recording paper 70 passes through the fixing nip region 15c, the fixing belt 30 abutting against a toner image bearing surface of the recording paper 70, while the pressure roller 15b abutting against a surface that is on opposite side of the toner image bearing surface, and a width of recording paper conveying direction C of the fixing nip region 15c (hereinafter, referred to as “fixing nip width”) is 7 mm.

[Fixing Roller]

The fixing roller 15a forms the fixing nip region 15c by being in pressure-contact with the pressure roller 15b with the fixing belt 30 interposed therebetween, and conveys the fixing belt 30 by rotational driving in a rotating direction A around a rotation axis by a driving motor (driving section). The fixing roller 15a has a diameter of 30 mm, and is comprised of a two-layer structure in which a metal core and an elastic layer are formed in this order from the inner side, and for the metal core, metal such as iron, stainless steel, aluminum, or copper, or alloy thereof is used. Furthermore, for the elastic layer, a rubber material having heat resistant property such as silicone rubber or fluoro-rubber is appropriate. Note that, in this embodiment, the fixing roller 15a is comprised of a metal core which is stainless steel whose diameter is 15 mm, and an elastic layer which is a silicone sponge rubber whose thickness is 7.5 mm. Further in this embodiment, a force that the fixing roller 15a is in pressure-contact with the pressure roller 15b through the fixing belt 30 is around 216 N.

[Pressure Roller]

The pressure roller 15b facing the fixing roller 15a with the fixing belt 30 interposed therebetween while being in pressure-contact with the fixing roller 15a, is provided around a rotation axis so as to be freely rotatable. The pressure roller 15b rotates around a rotation axis by a driving motor (driving section) in a rotating direction B which is an opposite direction to the rotation of the fixing roller 15a. The pressure roller 15b is comprised of a three layer structure in which a metal core, an elastic layer, a release layer are formed in this order from the inner side. For the metal core, metal such as iron, stainless steel, aluminum, or copper, or alloy thereof is used. Furthermore, for the elastic layer, a rubber material having heat resistant property such as silicone rubber or fluoro-rubber is appropriate, and for the release layer, a fluorine resin such as PFA (copolymer of tetrafluoroethylene and perfluoroalkyl vinyl ether) or PTF (polytetrafluoroethylene) is appropriate. For the pressure roller 15b, a roller whose roller diameter is 30 mm, comprised of an iron (STKM) pipe whose diameter is 28 mm (wall thickness of 1 mm) as a metal core, a silicone solid rubber whose thickness is 1 mm as an elastic layer, and a PFA tube whose thickness is 30 μm as a release layer is able to be used.

[Fixing Belt]

The fixing belt 30 is heated by the heating section 20 to a predetermined temperature, and heats the recording paper 70 on which an unfixed toner image 71 is formed which passes through the fixing nip region 15c. The fixing belt 30 is an endless-shaped belt member, which is supported around a heating base material 212 included in a heating member 21 of the heating section 20 and the fixing roller 15a with tension, and wound on the fixing roller 15a at a predetermined angle θ1 (in this embodiment, θ1=185°). The fixing belt 30 rotates in the rotating direction A driven by the fixing roller 15a, during rotation of the fixing roller 15a. The fixing belt 25 has a three-layer structure which is, on a surface of a hollow cylinder-shaped base material comprised of heat resistant resin such as polyimide or metal material such as stainless or nickel, as an elastic layer, an elastomer material (such as silicone rubber) exhibiting excellent heat resistance and elasticity is formed, and further on the surface, as a release layer, synthetic resin material (for example, a fluorine resin such as PFA or PTFE) exhibiting excellent heat resistance and releasability is formed. Additionally, a fluorine resin is able to be internally added to the base material of polyimide. Thereby, slide load between the heating member and the heating base material 212 is able to be reduced. In this embodiment, the fixing belt is an endless-shaped belt whose diameter is 45 mm, comprised of a base material of polyimide whose thickness is 70 μm, an elastic layer of silicone rubber whose thickness is 150 μm, and a release layer of PFA tube whose thickness is 30 μm.

Furthermore, in the fixing device 15, as a temperature detection section, in the vicinity of the circumferential surface of the fixing belt 30 that comes in contact with the heating base material 212 included in the heating member 21 of the heating section 20, a heating-element-side thermistor 32, and in the vicinity of the circumferential surface of the pressure roller 15b, a pressure-roller-side thermistor 33, are disposed to detect surface temperature thereof respectively. The heating-element-side thermistor 32 in this embodiment is a temperature detection section of a non-contact type, and a temperature sensor of an infrared ray detection type. In the configuration that a temperature detection section of a contact type is disposed in contact with the fixing belt 30, there may be a case where the temperature detection section of the contact type wears away the surface release layer of the fixing belt 30 in a boundary surface contacting the fixing belt 30. In the case where the surface release layer is damaged or deteriorated as such, the fixation performance may be affected such that an inferior fixed image is formed on the recording paper 70. In addition, the pressure-roller-side thermistor 33 is the temperature detection section of the contact type.

[Heating Section]

A heating section 20 provided in a fixing device 15 heats a toner image 71 on recording paper 70 through a fixing belt 30. Then, the heating section 20 has a heating operation mode in which a heating operation is performed for heating the toner image 71 on the recording paper 70 at a predetermined fixation temperature, and a warm-up mode as a state before the heating operation, which is a mode performed until a temperature of a ceramic heat generating element 211 described below rises from a normal temperature (20° C.) to a predetermined temperature (200° C.).

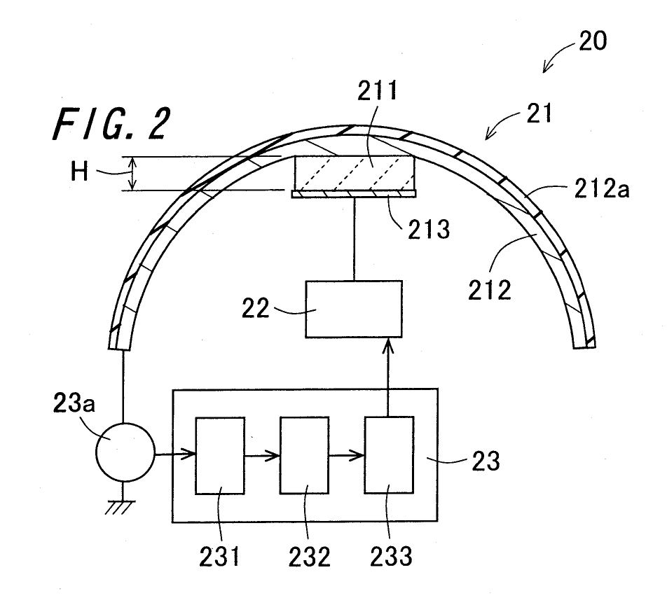

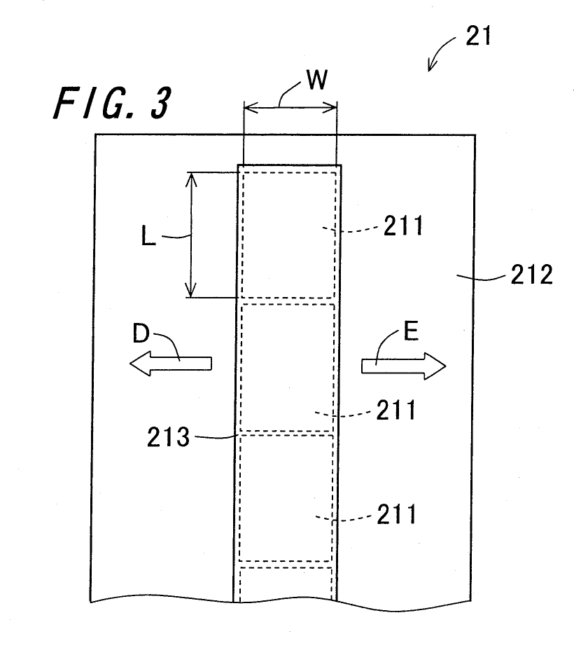

FIG. 2 is a view showing a configuration of the heating section 20. In addition, FIG. 3 is a plan view showing a configuration of a heating member 21. The configuration of the heating section 20 will hereinafter be described in detail with reference to FIGS. 2 and 3. The heating section 20 includes the heating member 21, a voltage variable power source 22, and a control unit 23.

Further, the heating section 20 includes a second heat generating element which is different from the ceramic heat generating element 211 of the heating member 21 described below. In this embodiment, the second heat generating element is a heater lamp 31 (for example, rated power of 400 W) comprised of a halogen heater which is disposed inside a pressure roller 15b. The control unit 23 described below supplies (electrifies) power to the heater lamp 31 from a power source circuit, whereby the heater lamp 31 emits light and an infrared ray is irradiated from the heater lamp 31. Whereby, an inner circumferential surface of the pressure roller 15b is heated by absorbing the infrared ray, and the entire pressure roller 15b is heated.

In this embodiment, the ceramic heat generating element 211 and the heater lamp 31 included in the heating section 20 generate heat in a distinguished state by applying voltages from different power sources. Therefore, the heating section 20 is to be the one capable of widening a control range of heating conditions for the toner image 71 on the recording paper 70 depending on quality of the recording paper 70, and a temperature of an environment in which the fixing device 15 is disposed, and a mode.

In addition, the heating section 20 is configured to heat the fixing belt 30 abutting against a toner image bearing surface of the recording paper 70 with heat from the ceramic heat generating element 211, and heat the pressure roller 15b abutting against a surface opposite to the toner image bearing surface with heat from the heater lamp 31. It is thereby possible to prevent that a temperature of a surface of the pressure roller 15b becomes too low for a surface of the fixing belt 30 in the heating operation mode. Therefore, it is possible to prevent that the recording paper 70 curls much to upward direction (direction to a side of the fixing belt 30) thereof, and prevent that retransfer to the rear surface of the recording paper 70 is promoted and toner dirt is accumulated on the pressure roller 15b even though the toner image 71 is adhered to the pressure roller 15b. In addition, the heating section 20 is able to heat from both surfaces of a thickness direction of the recording paper 70, thus is able to improve fixation performance.

<Heating Member>

The heating member 21 includes the ceramic heat generating element 211 which has a positive temperature coefficient (PTC) property and generates heat with predetermined thermal energy by electric power supply, a heating base material 212, and a power feeding electrode 213. In the heating member 21 in this embodiment, the heating base material 212 is the one in which a plate-like member is curved such that a cross-section shape taken along from an axial direction is to be an approximately semicircular shape, and the ceramic heat generating element 211 is disposed in contact with a center part in a circumferential direction of an inner circumferential surface of the heating base material 212 with silicone grease interposed therebetween, and in the ceramic heat generating element 211, on a surface opposite to the surface in contact with the heating base material 212, a power feeding electrode 213 composed of aluminum is provided by being pressed through silicone grease. Then, in the heating member 21, heat generated in the ceramic heat generating element 211 by voltage applied from a voltage variable power source 22 via the power feeding electrode 213, is conducted to the heating base material 212, and heats the fixing belt 30 which is in contact with an outer circumferential surface of the heating base material 211.

The ceramic heat generating element 211 having the PTC property is a ceramic heat generating element made of barium titanate, and has the property that an electric resistance value of the element changes suddenly when the temperature of the element rises above a certain temperature (Curie point), i.e., a self-temperature controlling property. This embodiment employs the ceramic heat generating element 211 of the specification that the electric resistance value suddenly increases above the Curie point of 220° C.

In addition, in the heating member 21 in this embodiment, one ceramic heat generating element 211 has an element size whose width dimension W corresponding to the circumferential direction of the heating base material 212 of 12.3 mm, dimension L corresponding to the axial direction L of 30 mm, and thickness H of 2.1 mm. Then, in the heating member 21, a plurality of (ten) ceramic heat generating elements with the element size are arranged between both edge parts of the axial direction of the heating base material 212 and fixed through silicone grease in the center part of the circumferential direction of the inner circumferential surface of the heating base material 212. In this way, the heating member 21 comprised of a plurality of ceramic heat generating elements 211, the dimension L of which is appropriately small, arranged between the both edge parts of the axial direction of the heating base material 212, is able to be produced more easily than in the case of being comprised of one ceramic heat generating element whose dimension L is large, thus producing cost is able to be reduced.

In addition, an electric resistance value of one ceramic heat generating element 211 is 350Ω under a normal temperature (20° C.) environment, and a total electric resistance value of ten ceramic heat generating elements 211 is 35Ω. Then, a temperature of each ceramic heat generating element 211 rises to 210 to 220° C. by voltage applied from the voltage variable power source 22 via the power feeding electrode 213, whereby a surface temperature of the fixing belt 30 which is in contact with the outer circumferential surface of the heating base material 212 is to be a predetermined fixation temperature (for example, 180° C.).

In a case where recording paper 70 of ordinary size (here, A4-size) is passed through the fixing nip region 15c consecutively, the heat generated by the ceramic heat generating element 211 is uniformly conducted to the recording paper 70. Thus, the fixing belt 30 comes to have a uniform temperature distribution of about the fixing temperature with respect to the width direction thereof. In a case where recording paper 70 of smaller size (here, A5-size) is passed through the fixing nip portion 15c consecutively, the heat generated by the ceramic heat generating element 211 is not conducted to the recording paper 70 at paper non-passing parts lying on opposite sides of the fixing belt 30 in the width direction thereof, and the temperature of the paper non-passing parts rises to the predetermined fixing temperature or above. In the ceramic heat generating element 211 whose temperatures have exceeded 220° C. of the Curie point due to the heat of the paper non-passing parts of the fixing belt 30, its electric resistance value increases. As a result, a current flowing through the ceramic heat generating element 211 is suppressed, and the heat generation of the ceramic heat generating element 211 stops. Therefore, the temperature rise of the paper non-passing parts of the fixing belt 30 is suppressed.

The heating base material 212 included in the heating member 21 is the one in which a plate-like member is curved such that a cross-section shape taken along from an axial direction is to be an approximately semicircular shape, and an outer circumferential surface thereof abuts against the entire width direction of the fixing belt 30. In this embodiment, the heating base material 212 has a diameter related to the circumferential direction of 28 mm and is set to have thickness of 1 mm. In addition, related to the circumferential direction of the heating base material 212, a width (heating nip width) dimension in contact with the fixing belt 30 is 44 mm.

Then, in the heating base material 212, heat generated in the ceramic heat generating element 211 which is in contact in the center part of the circumferential direction, is conducted and diffused toward the both end parts of the circumferential direction (toward a direction D and a direction E), and thereby heats the fixing belt 30 which is in contact with the heating base material 212. In this way, since the heating member 21 is configured such that the plate-like member heats the fixing belt 30 with the curved heating base material 212 interposed therebetween, it is possible to broaden the heating nip width more than in the configuration of heating the fixing belt 30 not through the heating base material 212, and heat the fixing belt 30 efficiently.

Materials constituting the heating base material 212, in the case of the ones exhibiting excellent heat conductivity and heat diffusion property, are not particularly limited, and may include aluminum, copper, and a self-excited oscillation heat pipe such as Heatlane (registered trademark).

In the case where a material constituting the heating base material 212 is made of aluminum or copper, aluminum and copper are excellent in thermal conductivity and also in workability and economy among metals. Therefore, owing to the fact that the material constituting the heating base material 212 is made of aluminum or copper, it is possible to realize the heating base material 212 which is excellent in workability and economy, which can widen the heating range in the fixing belt 30 more and which can increase the quantity of heat supply of the fixing belt 30 more. Accordingly, the heating performances of the ceramic heat generating elements 211 having the PTC property can be enhanced still more, and hence, the fixing device 15 of still higher operating speed can be realized.

Besides, in the case where a material constituting the heating base material 212 is configured of the self-excited oscillation heat pipe such as Heatlane (registered trademark), the self-excited oscillation heat pipe is still lower in thermal resistance than aluminum and copper which are excellent in thermal conductivity among metals, and it is excellent in heat diffusibility. Therefore, owing to the fact that the heating base material 212 is configured of the self-excited oscillation heat pipe, it is possible to realize the heating base material 212 which can widen the heating range in the fixing belt 30 more and which can increase the quantity of heat supply of the fixing belt 30 more. Accordingly, the heating performance of the ceramic heat generating elements 211 having the PTC property can be enhanced still more, and hence, the fixing device 15 of still higher operating speed can be realized.

In addition, in the heating base material 212, a coat layer 212a with insulating property is formed on the outer circumferential surface which is in contact with the fixing belt 30. The coat layer 212a is a layer made of a fluorine resin such as PTFE, and thickness thereof is 20 μm in this embodiment. In this way, the coat layer 212a is formed on the outer circumferential surface which is in contact with the fixing belt 30, of the heating base material 212, and it is thereby possible to reduce slide load between the heating base material 212 and the fixing belt 30, thus enabling smooth slide of the fixing belt 30.

<Voltage Variable Power Source>

The voltage variable power source 22 is connected to the ceramic heat generating element 211 via the power feeding electrode 213, is a power source for applying a voltage to the ceramic heat generating element 211, and is the one capable of variable control of applied voltage value. An applied voltage variable range in the voltage variable power source 22 is 80 to 230 V.

<Control Unit>

The control unit 23 controls electric power supply to the ceramic heat generating element 211 and the heater lamp 31 so that a surface temperature of the fixing belt 30 and the pressure roller 15b is to be a predetermined fixation temperature based on temperature data detected by the heating-element-side thermistor 32 and a pressure-roller-side thermistor 33. At this time, the control unit 23 is configured so as to variably control the applied voltage value by the voltage variable power source 22 to the ceramic heat generating element 211 so that an input power value in the ceramic heat generating element 211 is to be approximately constant. Here, “an input power value is approximately constant” means a power value in a range of ±15% to a target input power value. Then, as shown in FIG. 2, the control unit 23 includes a detection section 231, a calculation section 232, and a control section 233.

The detection section 231 detects a current value or electric resistance value which vary in accordance with a temperature in the ceramic heat generating element 211, and realize a detecting step. In this embodiment, the detection section 231 detects the current value of the ceramic heat generating element 211 measured by an ammeter 23a which is connected on a bias line of the ceramic heat generating element 211 in 0.2-second periods.

The calculation section 232 calculates an applied voltage value with which an input power value to the ceramic heat generating element 211 is approximately constant, based on the detection results from the detection section 231 and temperature data detected by the heating-element-side thermistor 32, and realizes a calculating step. In this embodiment, the calculation section 232 calculates an applied voltage value in 0.2-second periods in accordance with the current value detected by the detection section 231 in 0.2-second periods.

The control section 233 causes the voltage variable power source 22 to apply a voltage corresponding to the applied voltage value calculated by the calculation section 232 in 0.2-second periods to the ceramic heat generating element 211, and realizes a voltage applying step. In addition, the control section 233 causes a power source different from the voltage variable power source 22 to apply a voltage to the heater lamp 31 so that a surface temperature of the pressure roller 15b is to be a predetermined fixation temperature, based on temperature data detected by the pressure-roller-side thermistor 33.

The control unit 23 including the detection section 231, the calculation section 232 and the control section 233 as above feeds back the current value of the ceramic heat generating element 211 measured by the ammeter 23a to the voltage variable power source 22 in 0.2-second periods, and variably control the applied voltage value by the voltage variable power source 22 to an opposite direction to a direction of a change of the current value, so that an input power value in the ceramic heat generating element 211 is approximately constant.

Note that, when the detection section 231 is configured to detect an electric resistance value of the ceramic heat generating element 211, the control unit 23 may variably control the applied voltage value by the voltage variable power source 22 in the same direction as the direction of a change of the electric resistance value, so that an input power value in the ceramic heat generating element 211 is approximately constant.

The ceramic heat generating element 211 having the PTC property, even in a case where a temperature of the heat generating element is in a temperature range of a Curie point or lower, has slight temperature dependency and the electric resistance value varies. Therefore, in the case of applying a voltage to the ceramic heat generating element 211 having the PTC property using a power source of constant voltage (for example, 100 V), in accordance with variation of the electric resistance value with the temperature dependency, the input power value in the heat generating element also varies and it is not possible to obtain a constant power value which is necessary all the time. During a warm-up time when the temperature of the ceramic heat generating element 211 rises from a normal temperature (20° C.) to a predetermined temperature (200° C.), the electric resistance value of the ceramic heat generating element 211 varies within a range that a maximum electric resistance value is about 2.5 times as a minimum electric resistance value. In this way, when constant voltage is applied in a case where the electric resistance value in the ceramic heat generating element 211 varies, the input power value in the ceramic heat generating element 211 during warm-up varies within a range that the maximum power value is about 2.5 times as large as the minimum power value, and there is a possibility of exceeding a rated power value (commercial rated value: 1500 W). In addition, when constant voltage is applied to the ceramic heat generating element 211, in a case where the input power value in the ceramic heat generating element 211 during warm-up is tried not to exceed the rated power value, an average power value decreases and a warm-up time is caused to be long.

Against this, in the fixing device 15 of this embodiment, the control unit 23 variably controls the applied voltage value by the voltage variable power source 22 to the ceramic heat generating element 211, and it is thereby possible to cause the input power value in the ceramic heat generating element 211 to be approximately constant in accordance with variation of the electric resistance value even during the warm-up time when the temperature of the ceramic heat generating element 211 rises from the normal temperature (20° C.) to the predetermined temperature (200° C.). In this way, since the input power value in the ceramic heat generating element 211 is approximately constant during the warm-up time when the electric resistance value varies in accordance with the temperature change of the ceramic heat generating element 211, the warm-up time is prevented to be long. In addition, in the fixing device 15 of this embodiment, even in a case where a set value of a predetermined fixation temperature is changed in accordance with quality of the recording paper 70 and a temperature of an environment in which the fixing device 15 is installed, since the input power value in the ceramic heat generating element 211 is approximately constant, it is possible to secure stable fixation performance. Further, in the fixing device 15 of this embodiment, since the input power value in the ceramic heat generating element 211 is approximately constant in accordance with the variation of the electric resistance value accompanying temperature variation of the ceramic heat generating element 211, it is possible to exercise heating capability of the ceramic heat generating element 211 at a maximum without exceeding the rated power value (1500 W).

In addition, in an image forming apparatus 100 described below, in an image forming operation, the heating section 20 operates in a heating operation mode and the fixing device 15 operates, and the respective units corresponding to a toner image forming section other than the fixing device 15 operate, and during the warm-up time, the respective units other than the fixing device 15 do not operate. Therefore, it is possible to supply higher power in a warm-up mode than in a heating operation mode, to the ceramic heat generating element 211 of the heating section 20 (for example, in the heating operation mode: 900 W, whereas in the warm-up mode: 1200 W).

In a case where a halogen heater is used as a heat source for heating the toner image 71 on the recording paper 70, when trying to control the input power value to be 900 W under phase control in the heating operation mode, efficiency is lowered and only around 700 W is able to be obtained as effective power and power runs short. In this way, when the input power to the heat source runs short, temperature following property deteriorates.

Against this, in the fixing device 15 of this embodiment, it is preferable that the control unit 23 is configured to variably control the applied voltage value by the voltage variable power source 22 to the ceramic heat generating element 211 so that the input power value in the ceramic heat generating element 211 is approximately constant at higher value in the warm-up mode than in the heating operation mode. In the ceramic heat generating element 211, efficiency is not changed depending on the input power value, and further, the control unit 23 variably controls so that the input power value to the ceramic heat generating element 211 is approximately constant at higher value in the warm-up mode than in the heating operation mode, thus being able to achieve both shortening of the warm-up time and the temperature following property in a heating operation mode.

In addition, it is preferable that the control unit 23 is configured so as to variably control the applied voltage value by the voltage variable power source 22 to the ceramic heat generating element 211 so that the input power value is approximately constant at a higher value when the heater lamp 31 is not generating heat than when generating heat, depending on whether or not the heater lamp 31 is applied with voltage and is generating heat. It is thereby possible to prevent that power is unnecessarily consumed in the heating section 20 and secure stable fixation performance in accordance with quality of the recording paper 70, a temperature of an environment in which the fixing device 15 is installed and a mode thereof.

Next, description will be given for a configuration such that overcurrent does not flow through the ceramic heat generating element 211. When a maximum current value flowing through the ceramic heat generating element 211 is Imax (A), a maximum input power value is Pmax (W), and a rated voltage value is Vc (V), a condition in which Imax is not overcurrent is shown by the following formula (1).

Imax≦Pmax/Vc (1)

In addition, the current value flowing through the ceramic heat generating element 211 becomes the maximum current value Imax when an electric resistance value of the ceramic heat generating element 211 and an applied voltage value to the ceramic heat generating element 211 becomes minimum. When the electric resistance value is Rmin (Ω) and the applied voltage value is Vmin (V), the following formulae (2) and (3) are satisfied.

Vmin=Imax×Rmin (2)

Pmax=Imax×Vmin (3)

Further, the following formula (4) is derived from the above formula (2).

Vmin/Rmin=Imax (4)

In addition, the following formula (5) is derived from the above formulae (1) and (4).

Vmin/Rmin≦Pmax/Vc (5)

The following formula (6) is derived from the above formulae (3) and (5), and the following formula (7) is derived by changing the formula (6).

Vmin/Rmin≦Imax×Vmin/Vc (6)

1/(Imax×Rmin)≦1/Vc (7)

By changing the formula (7) derived in this manner, the following formula (i) is derived.

Vmin≧Vc (i)

That is, a calculation section 232 in the control unit 23 is configured so as to calculate the applied voltage value Vmin (V) within a range of satisfying the formula (i), and it is thereby possible to prevent that overcurrent exceeding rated current (15 A) flows through the ceramic heat generating element 211 and to secure safety.

In addition, the following formula (8) is derived from the above formulae (2) and (3), and the following formula (9) is derived by changing the formula (8).

Vmin/Rmin=Pmax/Vmin (8)

(Vmin)²=Pmax×Rmin (9)

Then, the following formula (10) is derived from the formulae (i) and (9), and the following formula (ii) is derived by changing the formula (10).

Pmax×Rmin≧Vc² (10)

Rmin≧Vc²/Pmax (ii)

That is, the ceramic heat generating element 211 serves as a member which is set so that Rmin (Ω) satisfies the formula (ii), and it is thereby possible to prevent that overcurrent exceeding the rated current flows through the ceramic heat generating element 211 and to secure safety.

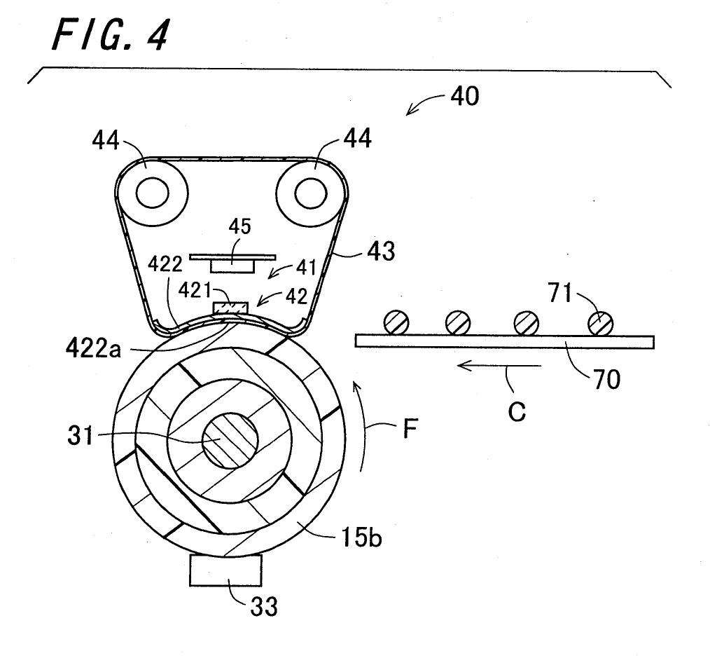

FIG. 4 is a view showing a configuration of a fixing device 40 according to a second embodiment of the invention. The fixing device 40 is similar to the above-described fixing device 15, and the corresponding parts are denoted by the same reference numerals and description thereof will be omitted.

The fixing device 40 includes the pressure roller 15b, a fixing belt 43 which is a film-like endless belt member, and a heating section 41. In the fixing device 40, the fixing belt 43 is supported around two supporting rollers 44 and a heating base material 422 included in the heating member 42 of the heating section 41 with tension, and the pressure roller 15b is disposed so as to face the heating base material 422 with the fixing belt 43 interposed therebetween. Then, the fixing device 40 is a device for heating and pressurizing the toner image 71 to fix on the recording paper 70 when the heating base material 422 comes in contact with an inner circumferential surface of the fixing belt 43 to heat the fixing belt 43, and the recording paper 70 passes through the fixing nip region 422a which is formed between the heating base material 422 and the pressure roller 15b which are in pressure-contact with each other with the fixing belt 43 interposed therebetween. In addition, when the recording paper 70 passes through the fixing nip region 422a, the fixing belt 43 abuts against a toner image bearing surface of the recording paper 70, and the pressure roller 15b abuts against the surface opposite to the toner image bearing surface.

The fixing belt 43 has a three-layer structure in which an elastic layer and a release layer are formed on the surface of a base material, similarly to the fixing belt 30 included in the above-described fixing device 15. Then, the fixing belt 43 drivenly rotates by rotation of the pressure roller 15b to an F direction.

In the heating section 41, the heating base material 422 included in the heating member 42, is caused to be a shape curving along an outer circumferential surface of the pressure roller 15b, and the outer circumferential surface is caused to abut against the entire width direction of the fixing belt 43. Then, the ceramic heat generating element 421 having a PTC property is disposed in contact with the center part in the circumferential direction of the inner circumferential surface of the heating base material 422. Then, in the heating section 41, similarly to the heating section 20 included in the above-described fixing device 15, the voltage variable power source 22 is connected to the ceramic heat generating element 421 via the power feeding electrode, and the control unit 23 variably controls the applied voltage value by the voltage variable power source 22 to the ceramic heat generating element 421 so that the input power value in the ceramic heat generating element 421 is approximately constant.

In the fixing device 40 configured as above, the toner image 71 on the recording paper 70 is heated by the heating section 41 through the fixing belt 43 and pressurized by a pressure-contact force which generates between the heating base material 422 and the pressure roller 15b, therefore, it is possible to secure stable fixation performance. In addition, since the fixing device 40 is configured so that the heating base material 422 and the pressure roller 15b are in pressure-contact with each other with the fixing belt 43 interposed therebetween, even in a case where other member in pressure-contact with the pressure roller 15b is not provided, it is possible to impart a pressure-contact force to the toner image 71 on the recording paper 70 and simplify the configuration of the device.

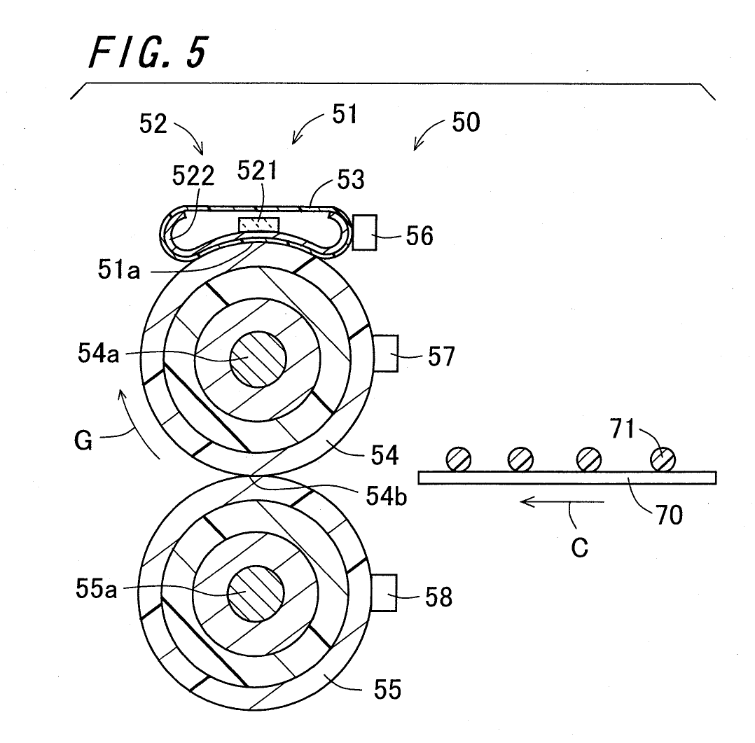

FIG. 5 is a view showing a configuration of the fixing device 50 according to a third embodiment of the invention. The fixing device 50 is similar to the above-described fixing device 15, and the corresponding parts are denoted by the same reference numerals and description thereof will be omitted. The fixing device 50 includes a heating section 51, a rotatable heating belt 53, a fixing roller 54, and a pressure roller 55.

In the fixing device 50, the fixing roller 54 is disposed so as to face the pressure roller 55, and a heating base material 522 included in the heating member 52 of the heating section 51 is disposed so as to face the fixing roller 54 with the heating belt 53 interposed therebetween. In the fixing device 50, the heating base material 522 comes in contact with an inner circumferential surface of the heating belt 53 to heat the heating belt 53. Then, heat held by the heating belt 53 is transmitted to the fixing roller 54 in a heating nip region 51a which is formed by that the fixing roller 54 comes in contact with an outer circumferential surface of the heating belt 53. Then, the fixing device 50 is a device for heating and pressurizing the toner image 71 to fix on the recording paper 70 when the recording paper 70 passes through a fixing nip region 54b which is formed between the fixing roller 54 and the pressure roller 55 which are in pressure-contact with each other. In addition, when the recording paper 70 passes through the fixing nip region 54b, the fixing roller 54 abuts against a toner image bearing surface of the recording paper 70, and the pressure roller 55 abuts against the surface opposite to the toner image bearing surface.

The fixing roller 54 rotates in a rotating direction G around a rotation axis by a driving section to convey the heating belt 53. The fixing roller 54 has a three-layer structure in which a metal core, an elastic layer, and a release layer are formed in this order from the inner side. Then, inside the pressure roller 54, a heater lamp 54a comprised of a halogen heater is disposed. In addition, in the vicinity of the circumferential surface of the pressure roller 54, a fixing-roller-side thermistor 57 as a temperature detection section is disposed to detect a surface temperature of the fixing roller 54.

The pressure roller 55, facing the fixing roller 54 and being in pressure-contact with the fixing roller 54, is rotatably provided around the rotation axis, and drivenly rotates by rotation of the fixing roller 54. The pressure roller 55 has a three-layer structure in which a metal core, an elastic layer, and a release layer are formed in this order from the inner side. Then, inside the pressure roller 55, a heater lamp 55a comprised of a halogen heater is disposed. In addition, in the vicinity of the circumferential surface of the pressure roller 55, a pressure-roller-side thermistor 58 as a temperature detection section is disposed to detect a surface temperature of the pressure roller 55.

In the heating section 51, the heating base material 522 included in the heating member 52, is caused to be a shape curving along an outer circumferential surface of the fixing roller 54, and the outer circumferential surface is caused to abut against the entire width direction of the heating belt 53. Then, the ceramic heat generating element 521 having a PTC property is disposed in contact with the center part in the circumferential direction of the inner circumferential surface of the heating base material 522. Then, in the heating section 51, similarly to the heating section 20 included in the above-described fixing device 15, the voltage variable power source 22 is connected to the ceramic heat generating element 521 via the power feeding electrode, and the control unit 23 variably control the applied voltage value by the voltage variable power source 22 to the ceramic heat generating element 521 so that an input power value in the ceramic heat generating element 521 is approximately constant.

The heating belt 53 is an endless-shaped belt member that is provided so as to be along the outer circumferential surface of the heating base material 522 that is formed to be curved, and has a three-layer structure in which an elastic layer and a release layer are formed on the surface of the base material similarly to the fixing belt 30 included in the above-described fixing device 15. Then, the heating belt 53 drivenly rotates by rotation of the fixing roller 54 in the direction G.

In the fixing device 50 configured as above, the toner image 71 on the recording paper 70 is heated by the heating section 51 through the heating belt 53 and the fixing roller 54 and pressurized by a pressure-contact force which generates between the fixing roller 54 and the pressure roller 55, therefore, it is possible to secure stable fixation performance.

(Image Forming Apparatus)

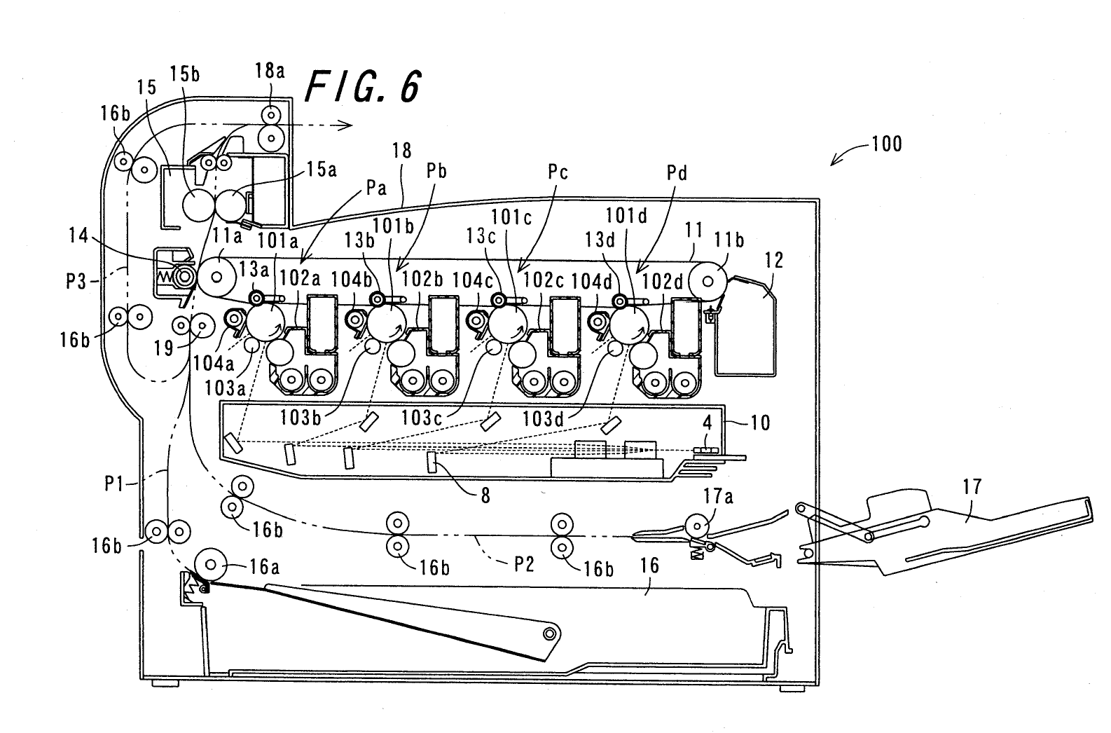

FIG. 6 is a view showing a configuration of an image forming apparatus 100 according to an embodiment of the invention. The image forming apparatus 100 is an apparatus that forms a multi-color or monochrome image on recording paper 70 based on image data read from a document or on image data transmitted through a network and the like. In this embodiment, the image forming apparatus 100 is a color multi-functional peripheral that forms a multi-color image. Then, the image forming apparatus 100 includes any one of the above-described fixing devices 15, 40, and 50 of this embodiment. A case where the image forming apparatus 100 includes the fixing device 15 will be described below.

The image forming apparatus 100 includes an optical system unit 10, a first visible image forming unit Pa, a second visible image forming unit Pb, a third visible image forming unit Pc and a fourth visible image forming unit Pd, an intermediate transfer belt 11, a secondary transfer unit 14, a fixing device 15, an inside paper feeding unit 16, a manual paper feeding unit 17, and a paper discharge unit 18. The first to fourth visible image forming units Pa to Pd, the intermediate transfer belt 11, and the secondary transfer unit 14 constitute a toner image forming section. Then, the image forming apparatus 100 uses image data corresponding to each of the four colors of black (K), as well as cyan (C), magenta (M), and yellow (Y), which are the three primary subtractive colors obtained by separating colors of a color image, forms a toner image corresponding to each color in the first to fourth visible image forming units Pa to Pd, and transfers the toner image to the intermediate transfer belt 11.

The first to fourth visible image forming units Pa to Pd, respectively, are similar to one another in configuration, and for example, the first visible image forming unit Pa for black (K) is constituted by a photoreceptor 101a, a charging unit 103a, a developing unit 102a, a primary transfer roller 13a, a cleaning unit 104a, and the like. Similarly, the second visible image forming unit Pb for cyan (C) is constituted by a photoreceptor 101b, a charging unit 103b, a developing unit 102b, a primary transfer roller 13b, a cleaning unit 104b, and the like. The third visible image forming unit Pc for magenta (M) is constituted by a photoreceptor 101c, a charging unit 103c, a developing unit 102c, a primary transfer roller 13c, a cleaning unit 104c, and the like. The fourth visible image forming unit Pd for yellow (Y) is constituted by a photoreceptor 101d, a charging unit 103d, a developing unit 102d, a primary transfer roller 13d, a cleaning unit 104d, and the like. The first to fourth visible image forming units Pa to Pd are arranged in alignment along a direction in which the intermediate transfer belt 11 moves (sub-scanning direction).

The charging units 103a to 103d are units for charging surfaces of the photoreceptors 101a to 101d uniformly to a predetermined potential, and for example, are contact-type roller-shaped chargers. Instead of the roller-shaped chargers, contact-type chargers using a charging brush, or noncontact-type chargers using a charging wire is also usable.

The optical system unit 10 includes a light source 4, a reflection mirror 8, and the like, and irradiates each of the photoreceptors 101a to 101d with each light beam such as a laser beam modulated according to image data corresponding to the respective colors of black (K), cyan (C), magenta (M), and yellow (Y). Each of the photoreceptors 101a to 101d forms an electrostatic latent image corresponding to the image data of the respective colors of black (K), cyan (C), magenta (M), and yellow (Y).

The developing units 102a to 102d supply a toner as a developer to surfaces of the photoreceptors 101a to 101d on which the electrostatic latent images are formed, to develop the electrostatic latent images to a toner image. The respective developing units 102a to 102d contain a toner of the respective colors of black (K), cyan (C), magenta (M), and yellow (Y), and visualize the electrostatic latent images formed on the respective photoreceptors 101a to 101d into toner images of the respective colors. The cleaning units 104a to 104d remove and collect residual toner on the surfaces of the photoreceptors 101a to 101d after development and image transfer.

The intermediate transfer belt 11 disposed above the respective photoreceptors 101a to 101d is supported around two tension rollers 11a and 11b with tension, without going slack, and forms a loop-shaped moving path. An outer circumferential surface of the intermediate transfer belt 11 faces the photoreceptor 101d, the photoreceptor 101c, the photoreceptor 101b and the photoreceptor 101a in this order. The primary transfer rollers 13a to 13d are disposed at positions facing the respective photoreceptors 101a to 101d with the intermediate transfer belt 11 interposed therebetween. The respective positions at which the intermediate transfer belt 11 faces the photoreceptors 101a to 101d are primary transfer positions.

A primary transfer bias having the opposite polarity to the charging polarity of the toner is applied by constant voltage control to the primary transfer rollers 13a to 13d in order to transfer the toner images borne on the surfaces of the photoreceptors 101a to 101d onto the intermediate transfer belt 11. Whereby, the toner images of the respective colors formed on the photoreceptors 101a to 101d are transferred and overlaid onto the outer circumferential surface of the intermediate transfer belt 11 on top of one another, and a full-color toner image is formed on the outer circumferential surface of the intermediate transfer belt 11.

However, when image data for only a part of the colors yellow (Y), magenta (M), cyan (C) and black (K) is inputted, electrostatic latent images and toner images are formed at only a part of the photoreceptors corresponding to the colors of the input image data among the four photoreceptors 101a to 101d. For example, during monochrome image formation, an electrostatic latent image and a toner image are formed only at the photoreceptor 101a corresponding to black color, and only a black toner image is transferred onto the outer circumferential surface of the intermediate transfer belt 11.

The toner image transferred onto the outer circumferential surface of the intermediate transfer belt 11 at each primary transfer position is conveyed to a secondary transfer position, which is a position facing the secondary transfer unit 14, by rotation of the intermediate transfer belt 11. The secondary transfer unit 14 is in pressure-contact, at a predetermined nip pressure, with the outer circumferential surface of the intermediate transfer belt 11 whose inner circumferential surface is in contact with a circumferential surface of the tension roller 11a during image formation. While the recording paper 70 fed from the inside paper feeding unit 16 or the manual paper feeding unit 17 passes between the secondary transfer unit 14 and the intermediate transfer belt 11, a high voltage with the opposite polarity to the charging polarity of the toner is applied to the secondary transfer unit 14. Thus, the toner image is transferred from the outer circumferential surface of the intermediate transfer belt 11 to the surface of the recording paper 70.

Note that, of the toner adhered from the photoreceptors 101a to 101d to the intermediate transfer belt 11, the toner that has not been transferred onto the recording paper 70 and remains on the intermediate transfer belt 11 is collected by a transfer cleaning unit 12 in order to prevent color mixture in the subsequent step.

The recording paper 70 onto which the toner image has been transferred is guided to the above-described fixing device 15 of the invention so as to pass through the fixing nip region to be heated and pressurized. Thus, the toner image is firmly fixed on the surface of the recording paper 70. The recording paper 70 on which the toner image has been fixed is discharged by paper discharging rollers 18a onto the paper discharge unit 18.

In addition, the image forming apparatus 100 includes a paper conveyance path P1 extending in the almost vertical direction so that recording paper 70 contained in the inside paper feeding unit 16 is conveyed through between the secondary transfer unit 14 and the intermediate transfer belt 11, and through the fixing device 15, to the paper discharge unit 18. Disposed in the paper conveyance path P1 are a pick-up roller 16a for sending the recording paper 70 in the inside paper feeding unit 16 into the paper conveyance path P1 sheet by sheet, conveying rollers 16b for conveying the sent recording paper 70 upward, registration rollers 19 for guiding the conveyed recording paper 70 between the secondary transfer unit 14 and the intermediate transfer belt 11 at predetermined timing, and the paper discharging rollers 18a for discharging the recording paper 70 to the paper discharge unit 18.

In addition, inside the image forming apparatus 100, a paper conveyance path P2 on which a pick-up roller 17a and conveying rollers 16b are disposed is formed between the manual paper feeding unit 17 and the registration rollers 19. Further, a paper conveyance path P3 is formed between the paper discharging rollers 18a and the upstream side of the registration rollers 19 in the paper conveyance path P1.

The paper discharging roller 18a freely rotates in both forward and reverse directions, and is driven in the forward direction to discharge recording paper 70 to the paper discharge unit 18 during single-sided image formation in which an image is formed on one side of the recording paper 70, and during second side image formation of double-sided image formation in which an image is formed on both sides of the recording paper 70. On the other hand, during first side image formation of double-sided image formation, the paper discharging roller 18a is driven in the forward direction until a tail end of the paper passes through the fixing device 15, and is then driven in the reverse direction to guide the recording paper 70 in the paper conveyance path P3 in a state where the tail end portion of the recording paper 70 is held. Thus, the recording paper 70 on which an image has been formed only on one side during double-sided image formation is guided to the paper conveyance path P1 in a state where the recording paper 70 is turned over and upside down.

The registration rollers 19 guide the recording paper 70 that has been fed from the inside paper feeding unit 16 or the manual paper feeding unit 17 and has been conveyed through the paper conveyance path P3, between the secondary transfer unit 14 and the intermediate transfer belt 11 at a timing synchronized with the rotation of the intermediate transfer belt 11. Thus, the rotation of the registration rollers 19 is stopped when the operation of the photoreceptors 101a to 101d or the intermediate transfer belt 11 is started, and the movement of the recording paper 70 that has been fed or conveyed prior to the rotation of the intermediate transfer belt 11 is stopped in the paper conveyance path P1 in a state where a leading end thereof abuts against the registration rollers 19. Then, the rotation of the registration rollers 19 is started at timing when the leading end portion of the recording paper 70 faces a leading end portion of a toner image formed on the intermediate transfer belt 11 at a position where the secondary transfer unit 14 is in pressure-contact with the intermediate transfer belt 11.

Note that, during full-color image formation in which image formation is performed by all of the first to fourth visible image forming units Pa to Pd, the primary transfer rollers 13a to 13d cause the intermediate transfer belt 11 to be in pressure-contact with all of the photoreceptors 101a to 101d. On the other hand, during monochrome image formation in which image formation is performed only by the first visible image forming unit Pa, only the primary transfer roller 13a causes the intermediate transfer belt 11 to be in pressure-contact with the photoreceptor 101a.

The image forming apparatus 100 configured as above is able to form a high-quality image at a high speed because of including the fixing device 15 in which the warm-up time is prevented to be long, and capable of securing stable fixation performance even in a case where a setting value of a predetermined fixation temperature is changed.

Note that, the image forming apparatus 100 of the inventions has a configuration including one fixing device 15, however, may be configured so as to include at least one fixing device selected from the fixing devices 15, 40, and 50 or may be configured to include a plurality of fixing devices.

(Control Program, Recording Medium)

In addition, as still another embodiment of the invention, it is possible to provide a control program for causing a computer to function as the control unit 23 of the above-described fixing devices 15, 40, and 50, and a computer-readable recording medium recording a program code (an executable program, an intermediate code program, and a source program) of the control program. According to this embodiment, a computer (or a CPU (Central Processing Unit) or an MPU (Micro Processing Unit)) provided in the image forming apparatus 100 reads the program code recorded on the recording medium and executes a command of the control program. The computer executes the command of the control program in this manner, and it is thereby possible to realize an operation of the fixing devices 15, 40, and 50 in which the warm-up time is prevented to be long and stable fixation performance is secured, and form a high-quality image at a high speed.

As a recording medium for recording the program code of the control program, for example, tapes such as a magnetic tape or a cassette tape; disks including magnetic disks such as a floppy (registered trademark) disk or a hard disk, and optical discs such as a CD-ROM (Compact Disc-Read Only Memory), an MO (Magneto Optical disc), an MD (Mini Disc), a DVD (Digital Versatile Disc), a CD-R (Compact Disc-Recordable), and a Blu-ray disc; cards such as IC (Integrated Circuit) card (including a memory card) or an optical card, and semiconductor memories such as a mask ROM, an EPROM (Erasable Programmable Read Only Memory), an EEPROM (Electrically Erasable Programmable Read Only Memory), or a flash ROM are usable.

In addition, the image forming apparatus 100 is configured so as to be connectable to a communication network and the program code of the control program may be supplied to the computer via the communication network. As this communication network, without particular limitation, for example, the Internet, an intranet, an extranet, a LAN (Local Area Network), an ISDN (Integrated Service Digital Network), a VAN (Value-added Network), a CATV (Community Antenna Television) communication network, a virtual private network, a telephone line network, a mobile communication network, a satellite communication network, and the like are usable. In addition, as a transmission medium constituting the communication network, without particular limitation, for example, lines such as an IEEE 1394 (Institute of Electrical and Electronic engineers 1394), a USB (Universal Serial Bus), a power line carrier, a cable TV line, a telephone line, an ADSL (Asymmetric Digital Subscriber Line), and radio waves including an infrared ray such as an IrDA (Infrared Data Association) or a remote control, a Bluetooth (registered trademark), an 802.11 radio wave, an HDR (High Data Rate), a mobile telephone network, a satellite circuit, and a terrestrial digital network are usable. Note that, the invention may be realized also in a form of a computer data signal embedded in a carrier wave in which the program code of the control program is embodied by an electronic transmission.

### EXAMPLES

Although the invention will hereinafter be described more in detail with reference to examples, the invention is not limited to these examples.

<Evaluation 1>

Using a fixing device of Examples 1 and 2, and Comparative Examples 1 and 2 shown below, a warm-up operation was performed from a normal temperature (20° C.) state, an input power value, an applied voltage value, a current value, an electric resistance value, and a temperature in a ceramic heat generating element during warm-up, were measured, and a warm-up time until a temperature of the ceramic heat generating element reached 200° C. was evaluated. Note that, although an original control is to complete warm-up when the temperature of the ceramic heat generating element reaches 200° C., electric power supply to the ceramic heat generating element was continued even in a temperature region exceeding 200° C. in order to confirm a PTC property of the ceramic heat generating element.

### Example 1

A fixing device used in Example 1 is the above-described fixing device 15 of this embodiment. In the fixing device of Example 1, as a heat source for heating a fixing belt, 10 ceramic heat generating elements whose total electric resistance value under the normal temperature (20° C.) environment is 23Ω were used. Then, a voltage variable power source was connected to the ceramic heat generating elements, and applied voltage to the ceramic heat generating element was variably controlled so that the input power value was constant at 1200 W.

### Example 2

The measurement was conducted in the same manner as Example 1 except for using 10 ceramic heat generating elements whose total electric resistance value is 35Ω in the normal temperature (20° C.) environment as a heat source for heating the fixing belt.

### Comparative Example 1

The measurement was conducted in the same manner as Example 1 except for that a constant voltage power source was connected to the ceramic heat generating element, and voltage to be applied to the ceramic heat generating element was constant at 100 V.

### Comparative Example 2

The measurement was conducted in the same manner as Example 2 except for that a constant voltage power source was connected to the ceramic heat generating element, and voltage to be applied to the ceramic heat generating element was constant at 100 V.

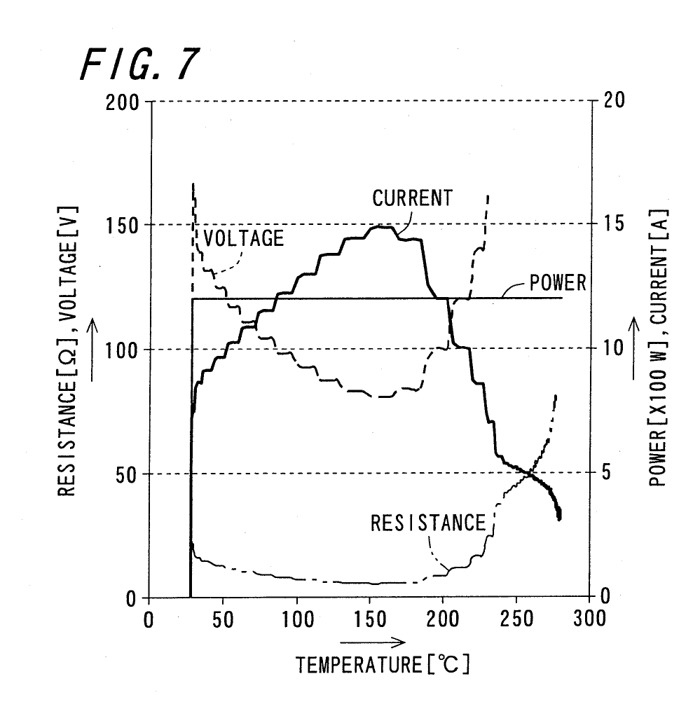

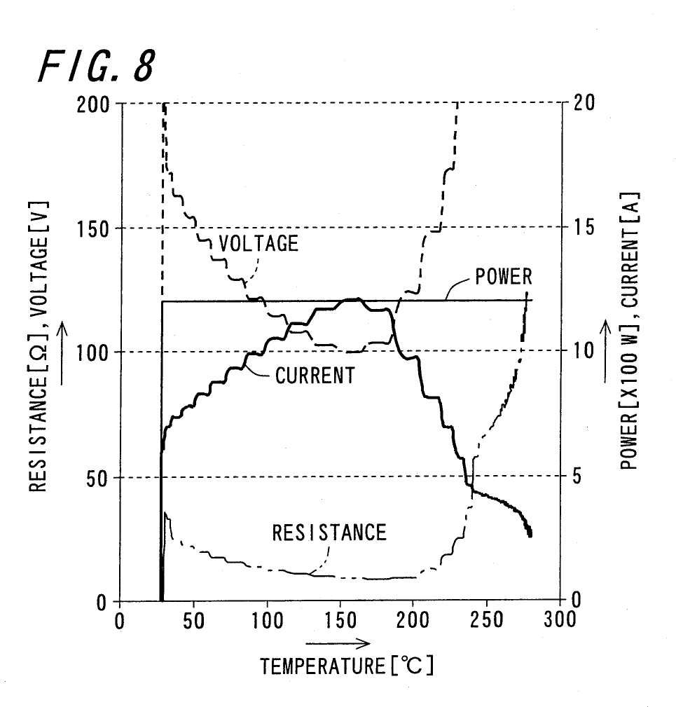

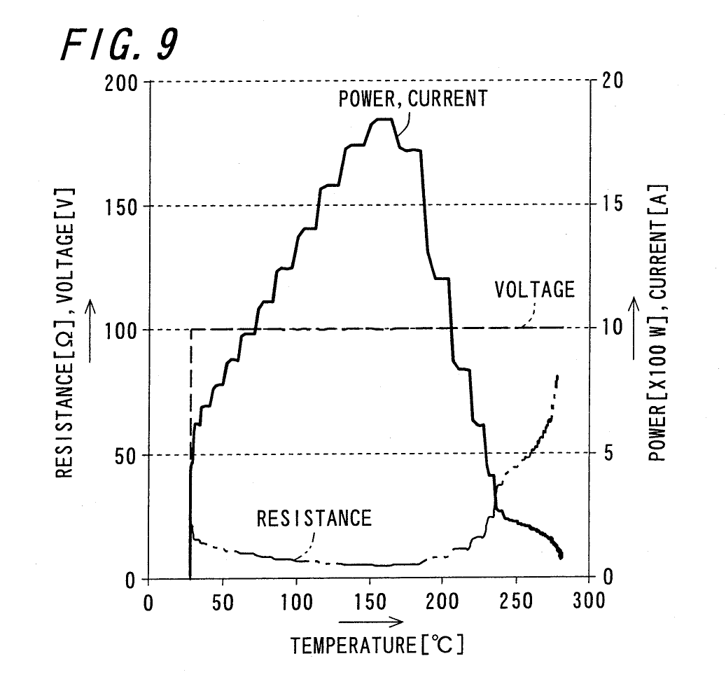

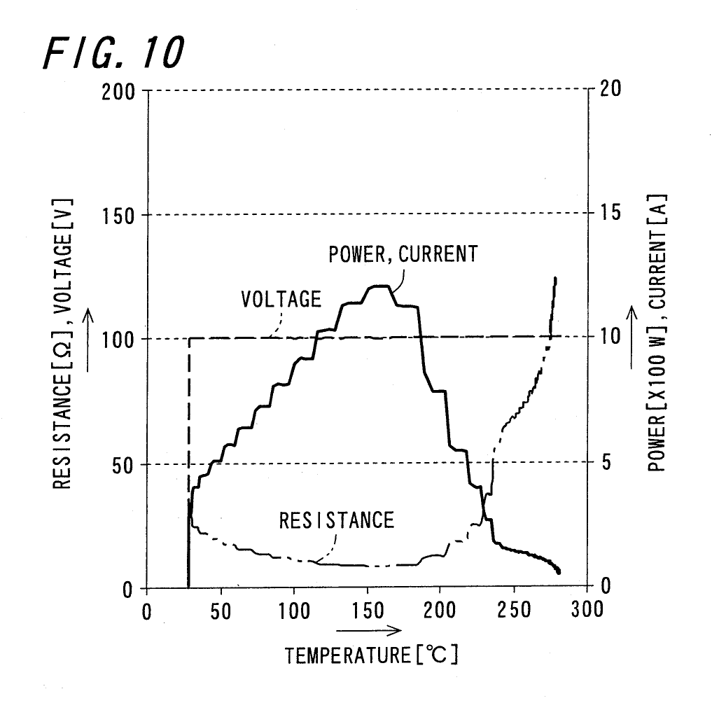

FIGS. 7 to 10 and Table 1 show evaluation results. FIG. 7 is a graph showing a relation between a temperature related to the ceramic heat generating element in a warm-up mode in the fixing device of Example 1, and an input power value, an applied voltage value, a current value and an electric resistance value. FIG. 8 is a graph showing a relation between a temperature related to the ceramic heat generating element in a warm-up mode in the fixing device of Example 2, and an input power value, an applied voltage value, a current value and an electric resistance value. FIG. 9 is a graph showing a relation between a temperature related to the ceramic heat generating element in a warm-up mode in the fixing device of Comparative Example 1, and an input power value, an applied voltage value, a current value and an electric resistance value. Then, FIG. 10 is a graph showing a relation between a temperature related to the ceramic heat generating element in a warm-up mode in the fixing device of Comparative Example 2, and an input power value, an applied voltage value, a current value and an electric resistance value.

TABLE 1

| | | | Comparative | Comparative |
|---|---|---|---|---|
| | Example 1 | Example 2 | Example 1 | Example 2 |
| Power source | Voltage | Voltage | Constant voltage | Constant voltage |
| | variable | variable | power source | power source |
| | power source | power source | | |
| Total electric resistance | 23 Ω (20° C.) | 35 Ω (20° C.) | 23 Ω (20° C.) | 35 Ω (20° C.) |
| value of heat | | | | |
| generating element | | | | |
| Warm-up time | 21 seconds | 21 seconds | 21 seconds | 33 seconds |
| Maximum power value | 1200 W | 1200 W | 1840 W | 1200 W |
| in heat generating | | | | |
| element | | | | |
| Average power value in | 1200 W | 1200 W | 1200 W | 758 W |
| heat generating | | | | |
| element | | | | |
| Maximum current value | 14.9 A | 12.0 A | 18.4 A | 12.0 A |
| flowing through heat | | | | |
| generating element | | | | |

As shown in FIGS. 7 to 10, in the ceramic heat generating element having the PTC property, when temperature exceeded the Curie point of 220° C., an electric resistance value suddenly increased. However, even in a temperature region of the Curie point or lower, the ceramic heat generating element had slight temperature dependency and the electric resistance value varied. Specifically, it turns out that the electric resistance value of the ceramic heat generating element in the temperature region of the Curie point or lower varies in a range that a maximum electric resistance value is about 4.2 times as large as a minimum electric resistance value (in the cases of Example 1 and Comparative Example 1, the maximum electric resistance value: 23Ω, and the minimum electric resistance value: 5.4Ω, and in the cases of the example 2 and the comparative example 2, the maximum electric resistance value: 35Ω, and the minimum electric resistance value: 8.3Ω).

In the fixing device of Comparative Examples 1 and 2 which is configured so as to apply constant voltage to the ceramic heat generating element having such property, the input power value in the ceramic heat generating element is made to vary (see FIGS. 9 and 10). At this time, in the fixing device of Comparative Example 1 in which the ceramic heat generating element with a low electric resistance value was used, the maximum input power value in the ceramic heat generating element is 1840 W, exceeding 1500 W as a commercial rated power value (see FIG. 9 and Table 1). In addition, in the fixing device of Comparative Example 2 in which the ceramic heat generating element with a high electric resistance value was used, even though the maximum input power value does not exceed the commercial rated power value, an average power value decreased and the warm-up time was longer (see FIG. 10 and Table 1).

Against this, in the fixing device of Examples 1 and 2 in which input power value to the ceramic heat generating element is constant at 1200 W, the result was that the warm-up time was prevented to be long without exceeding the commercial rated power value (see Table 1). In addition, in the fixing device of Example 2 in which the ceramic heat generating element with a high electric resistance value was used, the result was that it was possible to cause the maximum current value flowing though the heat generating element to be lower than the fixing device of Example 1 (see FIGS. 7 and 8, and Table 1).

<Evaluation 2>

Using a fixing device of Example 3, Comparative Examples 3 and 4 shown below, a warm-up operation was performed from the normal temperature (20° C.) state, and immediately after the warm-up was completed, 100 sheets of A4-size recording paper (plain paper: basis weight 64 g/m²) were passed through the fixing nip region consecutively at the speed of 50 sheets per minute (long edge feed), and evaluation was performed as to a warm-up time and temperature following property during a heating operation. Note that, a heater lamp disposed inside the pressure roller is used as a heat source to preheat the pressure roller during waiting, and the lamp is not lit during warm-up and the heating operation.

In addition, an evaluation criterion of the temperature following property was that, while 100 sheets of recording paper were passed through consecutively, a case where the decreased amount of a surface temperature of the fixing belt was within 10 deg for a target temperature 190° C. and fixation failure was not generated was “Good”, and a case where the decreased amount of a surface temperature of the fixing belt exceeded 10 deg for a target temperature 190° C. and fixation failure was generated was “Poor”.

### Example 3

The fixing device used in Example 3 is the same as that of Example 2. Then, in the example 3, control was made so that the input power value in the ceramic heat generating element was to be 1200 W during the warm-up time, and 900 W in the heating operation.

### Comparative Example 3

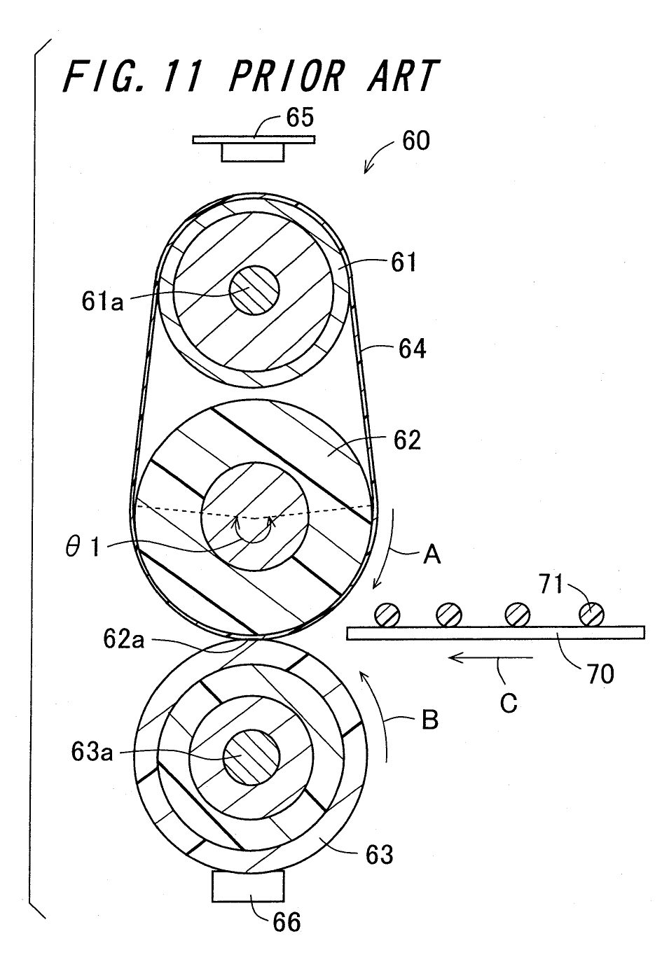

The fixing device used in Comparative Example 3 will be described with reference to FIG. 11. FIG. 11 is a view showing a configuration of a fixing device 60 of a conventional art. The fixing device 60 of the conventional art includes a heating roller 61, a fixing roller 62, a pressure roller 63, and a fixing belt 64. In the fixing device 60, the fixing belt 64 is supported around the heating roller 61 and the fixing roller 62 with tension, and the pressure roller 63 is disposed so as to face the fixing roller 62 with the fixing belt 64 interposed therebetween. Then, inside the heating roller 61, a belt-side heater lamp 61a comprised of a halogen heater is disposed to heat the fixing belt 64. In addition, also inside the pressure roller 63, a pressure-side heater lamp 63a comprised of a halogen heater is disposed. Then, when the heating roller 61 heats the fixing belt 64 and recording paper passes through the fixing nip region 62a which is formed between the fixing roller 62 and the pressure roller 63 which are in pressure-contact with each other with the fixing belt 64 interposed therebetween, the fixing device 60 heats and pressurizes a toner image to fix onto the recording paper. Note that, heater lamps 61a and 63a are configured so that an input power value is possible to vary under phase control.

In Comparative Example 3 in which the fixing device 60 as above was used, phase control was performed so that an input power value in the belt-side heater lamp 61a was to be 1200 W during a warm-up time and 900 W in a heating operation.

### Comparative Example 4

A fixing device used in Comparative Example 4 is the fixing device 60, similarly to Comparative Example 3. Then, in Comparative Example 4, phase control was performed so that an input power value in the belt-side heater lamp was to be 900 W during a warm-up time and 900 W in a heating operation.

Table 2 shows an evaluation result.

TABLE 2

| | | | Comparative | Comparative |
|---|---|---|---|---|
| | | Example 3 | Example 3 | Example 4 |
| Heat source to | Type of heat | Ceramic heat | Heater lamp | Heater lamp |
| fixing belt | source | generating | | |
| | | element | | |
| | Rated power | 1200 W | 1200 W | 900 W |
| | value | | | |
| Input power to | During | 1200 W | 1200 W | 900 W |
| heat source | warm- | | | |
| | up time | | | |
| | In heating | 900 W | 900 W | 900 W |
| | operation | | | |

| | | | |
|---|---|---|---|
| Warm-up time | 21 seconds | 21 seconds | 30 seconds |
| Temperature following | Good (0 deg) | Poor | Good (0 deg) |
| property | | (−20 deg) | |

As shown in FIG. 2, in the fixing device of Example 3, a warm-up time was as short as 21 seconds and temperature following property during a heating operation was good.

Against this, in the fixing device of Comparative Example 3, although a warm-up time was as short as 21 seconds, the temperature following property in the heating operation had a problem, a surface temperature of the fixing belt decreased 20 deg for a target temperature 190° C., and fixation failure was generated. The temperature fixation property deteriorated during the heating operation because, when trying to control the input power value to the belt-side heater lamp to be 900 W under phase control, efficiency is lowered and only around 700 W is able to be obtained as effective power, and power ran short. In addition, in the fixing device of the comparative example 4, temperature following property during the heating operation was good, however, the input power value to the belt-side heater lamp during a warm-up time was as low as 900 W, thus a warm-up time was caused to be long.

<Evaluation 3>

Using a fixing device of Example 4, Comparative Examples 5 and 6 described below, a warm-up operation was performed from the normal temperature (20° C.) state, and immediately after the warm-up was completed, 100 sheets of A4-size recording paper (plain paper: basis weight 64 g/m²) were passed through the fixing nip region consecutively at the speed of 50 sheets per minute (long edge feed), and an evaluation was performed as to temperature following property during a heating operation. Note that, a heater lamp disposed in the pressure roller is not only used as a heat source to preheat the pressure roller during waiting, but also the lamp was lit during the heating operation.

### Example 4

The fixing device used in Example 4 is the same as that of Example 2. In Example 4, control was made such that, power supply to the heater lamp is given priority when a surface temperature of the pressure roller has not reached a target temperature (130° C.) during a heating operation, and power corresponding to the rated power is supplied to the ceramic heat generating element only when the heater lamp has not been lit. Specifically, in Example 4, during a heating operation, an input power value to the ceramic heat generating element (the rated power 900 W) when a surface temperature of the fixing belt has not reached a target temperature (170° C.), was controlled to be 900 W when a surface temperature of the pressure roller has reached a target temperature (130° C.), and to be 400 W (an input power value to the heater lamp: 500 W that is corresponding to the rated power) when having not reached.

### Comparative Example 5

The fixing device used in Comparative Example 5 is the fixing device 60, similarly to Comparative Example 3. In the comparative example 5, control was made such that, power supply to the pressure-side heater lamp is given priority when a surface temperature of the pressure roller has not reached a target temperature (130° C.) during a heating operation, and power corresponding to the rated power is supplied to the belt-side heater lamp only when the pressure-side heater lamp has not been turned on. Specifically, in Comparative Example 5, during a heating operation, an input power value to the belt-side heater lamp (the rated power 900 W) when a surface temperature of the fixing belt has not reached a target temperature (170° C.), was controlled to be 900 W when a surface temperature of the pressure roller has reached a target temperature (130° C.), and to be 400 W (an input power value to the pressure-side heater lamp: 500 W that is corresponding to the rated power) when having not reached.

### Comparative Example 6

The fixing device used in Comparative Example 6 is the fixing device 60, similarly to Comparative Example 3. In Comparative Example 6, control was made such that, power supply to the belt-side heater lamp is given priority when a surface temperature of the fixing belt has not reached a target temperature (170° C.) during a heating operation, and power corresponding to the rated power is supplied to the pressure-side heater lamp only when the belt-side heater lamp has not been turned on. Specifically, in Comparative Example 6, during a heating operation, an input power value to the belt-side heater lamp (the rated power 900 W) when the surface temperature of the fixing belt has not reached a target temperature (170° C.), was controlled to be 900 W (an input power value to the pressure-side heater lamp: 0 W), whether or not a surface temperature of the pressure roller has reached a target temperature (130° C.).

Table 3 shows an evaluation result.

TABLE 3

| | | | Example 4 | | Comparative Example 5 | | Comparative Example 6 | |
|---|---|---|---|---|---|---|---|---|
| Heat source to | Type of heat source | | Ceramic heat generating | | Heater lamp | | Heater lamp | |
| fixing belt | | | element | | | | | |
| | Rated power value | | 900 W | | 900 W | | 900 W | |
| Heat source to | Type of heat source | | Heater lamp | | Heater lamp | | Heater lamp | |
| pressure roller | Rated power value | | 500 W | | 500 W | | 500 W | |
| | | | Input power value | | Input power value | | Input power value | |
| | | | | | | Pressure- | | Pressure- |
| | Temperature of | Temperature of | Ceramic heat | Heater | Belt-side | side heater | Belt-side | side heater |
| | fixing belt | pressure roller | generating element | Lamp | heater lamp | lamp | heater lamp | lamp |
| Input power value | ≧170° C. | ≧130° C. | 0 W | 0 W | 0 W | 0 W | 0 W | 0 W |
| control table | ≧170° C. | <130° C. | 0 W | 500 W | 0 W | 500 W | 0 W | 500 W |
| | <170° C. | ≧130° C. | 900 W | 0 W | 900 W | 0 W | 900 W | 0 W |
| | <170° C. | <130° C. | 400 W | 500 W | 400 W | 500 W | 900 W | 0 W |

| Fixation property | | No fixation failure | Fixation failure generated | Fixation failure generated |
|---|---|---|---|---|
| Temperature | Fixing belt side | Good (0 deg) | Poor (−13 deg) | Good (0 deg) |
| following property | Pressure roller side | Good (0 deg) | Good (0 deg) | Poor (−26 deg) |

As shown in Table 3, in the fixing device of Comparative Example 5, temperature following property in the fixing belt was poor, and fixing failure was generated. In addition, in the fixing device of Comparative Example 6, temperature following property in the pressure roller was poor, and fixing failure was generated.

Against this, in the fixing device of Example 4, during a heating operation, temperature following property in the fixing belt and the pressure roller was good, and fixing failure was not generated. This is because the ceramic heat generating element is a heat source whose efficiency is not changed by the input power value.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A fixing device comprising a heating section for heating a toner image borne on a fixing material, the heating section heating the toner image at a predetermined fixation temperature to fix the image on the fixing material, the heating section comprising:
a heating member including a ceramic heat generating element that generates heat by electric power supply and has a positive temperature coefficient property, and a heating base material through which heat generated from the ceramic heat generating element is conducted;
a voltage variable power source which applies a voltage to the ceramic heat generating element, the voltage variable power source being capable of variably controlling an applied voltage value; and
a control unit that variably controls the applied voltage value by the voltage variable power source to the ceramic heat generating element such that an input power value in the ceramic heat generating element is to be approximately constant.

2. The fixing device of claim 1, wherein the control unit comprises:
a detection section that detects a current value or electric resistance value of the ceramic heat generating element;
a calculation section that calculates the applied voltage value with which an input power value for the ceramic heat generating element is approximately constant based on the current value or electric resistance value detected by the detection section; and
a control section that causes the voltage variable power source to apply a voltage corresponding to the applied voltage value calculated by the calculation section.

3. The fixing device of claim 1, further comprising a fixing belt that is formed as an endless-shaped belt member and is disposed so as to rotate in contact of its outer circumferential surface with a toner image bearing surface of the fixing material on which a toner image is borne,
wherein the heating section is disposed such that the heating base material comes in contact with an inner circumferential surface of the fixing belt, and a toner image is heated through the fixing belt.

4. The fixing device of claim 3, further comprising a fixing member that is disposed in contact with the inner circumferential surface of the fixing belt, and a pressure member coming in pressure-contact with the fixing member with the fixing belt interposed therebetween,
wherein the heating section is configured so as to provide heat through the fixing belt, a toner image borne on a fixing material passing between the fixing belt and the pressure member.

5. The fixing device of claim 3, further comprising a pressure member coming in pressure-contact with the heating base material disposed so as to come in contact with the inner circumferential surface of the fixing belt, with the fixing belt interposed therebetween,
wherein the heating section is configured to heat a toner image borne on the fixing material passing between the fixing belt and the pressure member through the fixing belt.

6. The fixing device of claim 1, further comprising a fixing member that comes in contact with a toner image bearing surface of a fixing material on which a toner image is borne, a pressure member coming in pressure-contact with the fixing member, and a heating belt that is an endless-shaped belt member and is disposed so as to rotate in contact of its inner circumferential surface with the heating base material and in contact of its outer circumferential surface with the fixing member,
wherein the heating section is configured to heat a toner image borne on a fixing material passing between the fixing member and the pressure member through the heating belt and the fixing member.

7. The fixing device of claim 1, wherein the control unit is configured such that the applied voltage value by the voltage variable power source to the ceramic heat generating element is variably controlled in a direction opposite to a direction of change of a current value in the ceramic heat generating element.

8. The fixing device of claim 1, wherein the control unit is configured such that the applied voltage value by the voltage variable power source to the ceramic heat generating element is variably controlled in a direction same as the direction of a change of a resistance value in the ceramic heat generating element.

9. The fixing device of claim 1, wherein the heating section has a heating operation mode and a warm-up mode, the heating operation mode being a mode in which a heating operation is performed for heating a toner image borne on the fixing material at a predetermined fixation temperature, and the warm-up mode being a mode as a state before the heating operation which mode is performed until a temperature of the ceramic heat generating element rises from the normal temperature to the predetermined fixation temperature, and
the control unit is configured to variably control the applied voltage value by the voltage variable power source to the ceramic heat generating element such that the input power value in the ceramic heat generating element is approximately constant at a higher value in the warm-up mode than in the heating operation mode.

10. The fixing device of claim 2, wherein the control unit is configured such that, when the detection section detected a minimum electric resistance value Rmin (Ω) in a use temperature range of the ceramic heat generating element, the calculation section calculates the applied voltage value Vmin (V) within a range in which the following formula (i) is satisfied:
Vmin≧Vc (i)
where Vc is the rated voltage value.

11. The fixing device of claim 1, wherein the ceramic heat generating element is a member that is set such that, when a maximum input power value is Pmax (W), the minimum electric resistance value Rmin (Ω) within the use temperature range satisfies the following formula (ii):
Rmin≧Vc²/Pmax (ii)
where Vc is the rated voltage value.

12. The fixing device of claim 1, wherein the heating section includes a second heat generating element that is different from the ceramic heat generating element, and
the second heat generating element is configured to generate heat by applying a voltage from a second power source that is different from the voltage variable power source.

13. The fixing device of claim 12, wherein the second heat generating element is a halogen heater.

14. The fixing device of claim 12, wherein the control unit is configured to variably control the applied voltage value by the voltage variable power source to the ceramic heat generating element, depending on whether or not the second heat generating element generates heat by applying a voltage from the second power source, such that an input power value in the ceramic heat generating element is approximately constant at a higher value when the second heat generating element is not generating heat than when the second heat generating element is generating heat.

15. The fixing device of claim 12, wherein the second heat generating element is a heat source for heating the pressure member.

16. An image forming apparatus comprising:
a toner image forming section for forming a toner image on a fixing material; and
a fixing section for heating the toner image, which is the fixing device of claim 1, the fixing section heating the toner image formed on the fixing material by the toner image forming section to a predetermined fixation temperature to fix.

17. A computer-readable recording medium recording a control program for realizing the fixing device of claim 1, the control program causing a computer to function as the control unit.

18. A method of controlling a fixing device for heating a toner image borne on a fixing material to a predetermined fixation temperature to fix, with a heat source composed of a ceramic heat generating element which generates heat by electric power supply and has a positive temperature coefficient property, comprising:
a detecting step of detecting a current value or electric resistance value of the ceramic heat generating element;
a calculating step of calculating an applied voltage value with which an input power value to the ceramic heat generating element is approximately constant based on the current value or the electric resistance value detected at the detecting step; and
a voltage applying step of applying a voltage corresponding to an applied voltage value calculated in the calculating step to the ceramic heat generating element.
